(19) United States
(12) Patent Application Publication
(10) Pub. No.: US 2025/0012973 A1
(43) Pub. Date: Jan. 9, 2025

(54) INTERFACE STRUCTURE, OPTICAL CONNECTOR, TRANSMITTER, RECEIVER, OPTICAL CABLE, AND OPTICAL COMMUNICATION SYSTEM

(71) Applicant: SONY GROUP CORPORATION, TOKYO (JP)

(72) Inventors: HIROSHI MORITA, TOKYO (JP); KAZUAKI TOBA, TOKYO (JP); MASANARI YAMAMOTO, TOKYO (JP)

(21) Appl. No.: 18/712,343

(22) PCT Filed: Nov. 8, 2022
(86) PCT No.: PCT/JP2022/041619

§ 371 Date: May 22, 2024

(30) Foreign Application Priority Data
Nov. 30, 2021 (JP) 2021-193750

(51) Int. Cl. G02B 6/26; G02B 6/32; G02B 6/38; G02B 6/42

(52) U.S. Cl. CPC G02B 6/262; G02B 6/264; G02B 6/32; G02B 6/325; G02B 6/3883; G02B 6/4206; G02B 6/4214; G02B 6/4215; G02B 6/4231

(57) ABSTRACT

An amount of optical loss in spatial coupling can be properly reduced.

Provided are optical members, each constituting a light emitter or a light receiver, and a lens member having lens portions. A high-transmittance portion having a higher transmittance than the lens member is disposed between the optical member and the lens member. For example, a light emitter is an optical waveguide that emits an optical signal from one end of the optical waveguide or a light-emitting element that converts an electric signal into an optical signal and emits the signal, and a light receiver is an optical waveguide that receives an optical signal on one end of the optical waveguide or a light-receiving element that converts the received optical signal into an electric signal.

### TECHNICAL FIELD

The present technique relates to an interface structure, an optical connector, a transmitter, a receiver, an optical cable, and an optical communication system and specifically relates to an interface structure or the like that can properly reduce an amount of loss of light (optical signal) in spatial coupling.

### BACKGROUND ART

Conventionally, optical communications through spatial coupling (see, for example, PTL 1) are known. In this case, for example, light emitted from an optical fiber on the transmission side is emitted in the shape of a collimated light beam through a lens. The collimated beam is condensed through a lens on the reception side and is projected into an optical fiber.

### CITATION LIST

### Patent Literature

[PTL 1] WO 2017/056889

### SUMMARY

### Technical Problem

It is known that lenses used for spatial coupling on the transmission side and the reception side are machined and shaped using resin lens members because high workability is obtained at low cost. The resin lens members contain impurities mixed to improve hardness and workability and thus have lower transmittance than a glass member. The transmittance is, for example, about 80% to 90%.

In the case of consumer use, a collimated light beam may be increased in diameter to some extent in optical communications through spatial coupling. This allows communications even if fine wastes (dirt, dust) such as hairs enter the optical path of a collimated beam.

However, combined with the lens member having lower transmittance than the glass member, a collimated light beam increased in diameter may increase the thickness of a lens member between an optical fiber and a lens, that is, the length of the lens member in the axial direction, resulting in a larger amount of optical loss.

An object of the present technique is to properly reduce an amount of optical loss in spatial coupling.

### Solution to Problem

A concept of the present technique is represented by an optical interface structure including:
optical members, each constituting a light emitter or a light receiver, and a lens member having lens portions,
wherein a high-transmittance portion having a higher transmittance than the lens member is disposed between the optical member and the lens member.

The optical interface structure according to the present technique includes optical members, each constituting a light emitter or a light receiver, and a lens member having lens portions. Moreover, a high-transmittance portion having a higher transmittance than the lens member is disposed between the optical member and the lens member.

For example, the light emitter may be an optical waveguide that emits an optical signal from one end of the optical waveguide or a light-emitting element that converts an electric signal into an optical signal and emits the signal. For example, the light receiver may be an optical waveguide that receives an optical signal on one end of the optical waveguide or a light-receiving element that converts the received optical signal into an electric signal.

For example, the lens member may be configured with a resin member, and the high-transmittance portion may be configured with a glass member or a space. In this case, for example, if the high-transmittance portion is a space, the thickness of the space may be kept at a predetermined thickness by a spacer.

For example, positioning between a ferrule holding the optical waveguide serving as the light emitter or the light receiver and the lens member may be performed by using a positioning pin. In this case, for example, the ferrule may hold the plurality of optical waveguides, and the lens member may have the plurality of lens portions for the respective optical waveguides.

For example, if the optical member is a light emitter, the lens portion included in the lens member may constitute a collimating lens. For example, if the optical member is a light receiver, the lens portion included in the lens member may constitute a condenser lens.

For example, the optical waveguide serving as the light emitter or the light receiver allows propagation only in a basic mode at a first wavelength, communications are performed using light having a second wavelength and the components of at least the components of the primary mode as well as the basic mode, and the second wavelength is a wavelength where the optical waveguide allows propagation at least in the primary mode as well as the basic mode. In this case, the coupling efficiency of optical power can be improved depending upon the direction of an optical axis misalignment.

In this case, for example, a lens configured to adjust an optical path may be disposed between the optical waveguide and the high-transmittance portion. In this case, the lens configured to adjust the optical path may have a refractive index of a gradation structure in which the refractive index decreases in the vertical direction from an optical axis. Since the lens configured to adjust an optical path is disposed thus, a coupling loss of optical power can be reduced, the coupling loss occurring through communications using light including the components of the primary mode as well as the basic mode.

As described above, in the present technique, the high-transmittance portion having a higher transmittance than the lens member is disposed between the optical member and the lens member, and an amount of optical loss caused by transmission through the lens member can be reduced by suppressing the thickness of the lens member, thereby properly reducing an amount of optical loss of an optical signal in spatial coupling.

Another concept of the present technique is represented by an optical connector including:
a lens member having lens portions, and
a high-transmittance portion that is disposed between an optical waveguide and the lens member and has a higher transmittance than the lens member.

The optical connector according to the present technique includes a lens member having lens portions, and a high-transmittance portion that is disposed between an optical waveguide and the lens member and has a higher transmittance than the lens member.

For example, the optical waveguide allows propagation only in the basic mode at the first wavelength, communications are performed using light having the second wavelength and the components of at least the components of the primary mode as well as the basic mode, and the second wavelength is a wavelength where the optical waveguide allows propagation at least in the primary mode as well as the basic mode. In this case, the coupling efficiency of optical power can be improved depending upon the direction of an optical axis misalignment.

In this case, for example, a lens configured to adjust an optical path may be disposed between the optical waveguide and the high-transmittance portion. In this case, the lens configured to adjust the optical path may have a refractive index of a gradation structure in which the refractive index decreases in the vertical direction from an optical axis. Since the lens configured to adjust an optical path is disposed thus, a coupling loss of optical power can be reduced, the coupling loss occurring through communications using light including the components of the primary mode as well as the basic mode.

As described above, in the present technique, the high-transmittance portion having a higher transmittance than the lens member is disposed between the optical waveguide and the lens member, and an amount of optical loss caused by transmission through the lens member can be reduced by suppressing the thickness of the lens member, thereby properly reducing an amount of optical loss of an optical signal in spatial coupling.

Another concept of the present technique is represented by a transmitter including: an optical connector configured to output an optical signal, the optical connector includes:
a lens member having lens portions configured to output the optical signal to the outside, the optical signal being emitted from one end of an optical waveguide; and
a high-transmittance portion that is disposed between the optical waveguide and the lens member and has a higher transmittance than the lens member.

Another concept of the present technique is represented by a receiver including: an optical connector configured to input an optical signal, the optical connector includes:
a lens member having lens portions configured to receive the optical signal on one end of an optical waveguide, the optical signal being inputted from the outside; and
a high-transmittance portion that is disposed between the lens member and the optical waveguide and has a higher transmittance than the lens member.

Another concept of the present technique is represented by an optical cable including:
an optical connector configured to input or output an optical signal,
the optical connector includes:
a lens member having lens portions, and
a high-transmittance portion that is disposed between the optical waveguide and the lens member and has a higher transmittance than the lens member.

Another concept of the present technique is represented by
an optical communication system in which a transmitter and a receiver are connected to each other via an optical cable,
wherein the transmitter, the receiver, and the optical cable each include an optical connector, and
the optical connector includes:
a lens member having lens portions, and
a high-transmittance portion that is disposed between the optical waveguide and the lens member and has a higher transmittance than the lens member.

### BRIEF DESCRIPTION OF DRAWINGS

FIG. 1 illustrates the outline of optical communications through spatial coupling.

FIG. 2 illustrates the basic structure of an optical fiber and the LPm1 mode of a step-index optical fiber.

FIG. 3 indicates a normalized frequency V in an ordinary case of 1310 nm in a single mode.

FIG. 4 illustrates an example of optical communications through spatial coupling.

FIG. 5 illustrates an example of optical communications through spatial coupling.

FIG. 6 is an explanatory drawing showing that the basic mode of LP01 and the primary mode of LP11 can be present when light with a wavelength of 850 nm is inputted to a 1310-nm single-mode fiber.

FIG. 7 shows that optical axis misalignment occurs on condition that only the basic mode of LP01 is present for input light.

FIG. 8 is a graph indicating the simulation result of a loss amount when input light has wavelengths of 1310 nm and 850 nm.

FIG. 9 shows that only the basic mode is present for input light in the absence of optical axis misalignment while the basic mode is partially converted into the primary mode in the presence of optical axis misalignment.

FIG. 10 is a graph for explaining the conversion of the basic mode into the primary mode according to a displacement.

FIG. 11 indicates simulations on the intensity distribution of light conveyed through the optical fiber.

FIG. 12 is an explanatory drawing of an angle of light emitted from a fiber end face.

FIG. 13 is an explanatory drawing of optical communications through spatial coupling.

FIG. 14 is an explanatory drawing of an optical axis misalignment occurring such that the position of the optical fiber is vertically shifted with respect to a lens.

FIG. 15 is a graph indicating the simulation result of coupling efficiency of optical power.

FIG. 16 is an explanatory drawing of an optical axis misalignment occurring such that the position of the optical fiber is vertically shifted with respect to a lens.

FIG. 17 is a graph indicating the simulation result of coupling efficiency of optical power.

FIG. 18 illustrates an example in which a lens serving as an optical path adjusting unit is provided on the entry side of the optical fiber.

FIG. 19 is a graph indicating the simulation result of coupling efficiency of optical power.

FIG. 20 is a graph indicating a basic mode (zeroth-order mode) component and a primary mode component in a separated manner.

FIG. 21 illustrates an example in which a GRIN lens serving as the optical path adjusting unit is provided on the entry side of the optical fiber.

FIG. 22 is an explanatory drawing of the reason why light can be returned to a central direction even if an optical axis misalignment occurs.

FIG. 23 is a graph indicating the simulation result of coupling efficiency of optical power.

FIG. 24 is a graph indicating a basic mode (zeroth-order mode) component and a primary mode component in a separated manner.

FIG. 25 illustrates an example in which the lens GRIN lens serving as the optical path adjusting unit is provided on the reception side and an identical GRIN lens is provided on the transmission side.

FIG. 26 is an explanatory drawing of the GRIN lens.

FIG. 27 is an explanatory drawing of an optical axis misalignment occurring such that the positions of the optical fiber and the GRIN lens on the reception side are vertically shifted with respect to a lens (condenser lens).

FIG. 28 is a graph indicating the simulation results of resistance to an optical axis misalignment when pitches are changed (coupling efficiency of optical power).

FIG. 29 is an explanatory drawing of the correspondence relationship between a thickness (lens thickness) of a lens member on the transmission side and a diameter of a collimated light beam.

FIG. 30 is an explanatory drawing indicating a problem of an amount of optical loss that increases when the thickness (lens thickness) of the lens member increases.

FIG. 31 is an explanatory drawing of a structure in which a high-transmittance portion is disposed.

FIG. 32 is a perspective view illustrating a configuration example of the connector of a transmitter and the connector of a cable.

FIG. 33 is a perspective view illustrating a configuration example of the connector of the transmitter and the connector of the cable.

FIG. 34 is a cross-sectional view illustrating a configuration example of an optical connector on the transmission side and an optical connector on the reception side.

FIG. 35 is a cross-sectional view illustrating an example of a state in which the optical connector on the transmission side and the optical connector on the reception side.

FIG. 36 is a perspective view illustrating another configuration example of the connector of the transmitter and the connector of the cable.

FIG. 37 is a perspective view illustrating another configuration example of the connector of the transmitter and the connector of the cable.

FIG. 38 illustrates an example of a structure not provided with the GRIN lens.

FIG. 39 illustrates a configuration example of optical coupling between a light-emitting portion and the optical fiber.

FIG. 40 illustrates another configuration example of optical coupling between the light-emitting portion and the optical fiber.

FIG. 41 illustrates another configuration example of optical coupling between the light-emitting portion and the optical fiber.

### DESCRIPTION OF EMBODIMENTS

A mode for carrying out the present invention (hereinafter referred to as “embodiment”) will be described below. The descriptions will be given in the following order.
1. Embodiment
2. Modification Example

### 1. Embodiment

### [Description of Technique Relevant to Embodiment]

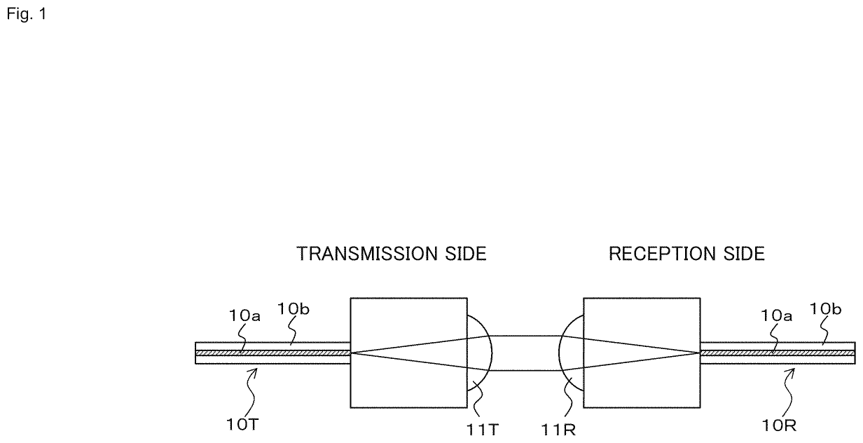

First, a technique relevant to an embodiment will be described below. FIG. 1 illustrates the outline of optical communications through space coupling. In this case, light emitted from an optical fiber 10T on the transmission side is emitted in the shape of a collimated light beam through a lens 11T. The collimated light beam is then condensed through a lens 11R on the reception side and is projected into an optical fiber 10R. In the case of such optical communications, a displacement causes a large loss of optical power particularly in a single-mode fiber. The optical fibers 10T and 10R each have a double structure including a core 10a at a central portion serving as an optical path and a clad 10b surrounding the core 10a.

A basic concept of modes will be described below. In the case of propagation through the optical fiber in a single mode, parameters including a refractive index and a core diameter of the fiber need to be determined in the presence of only a single mode.

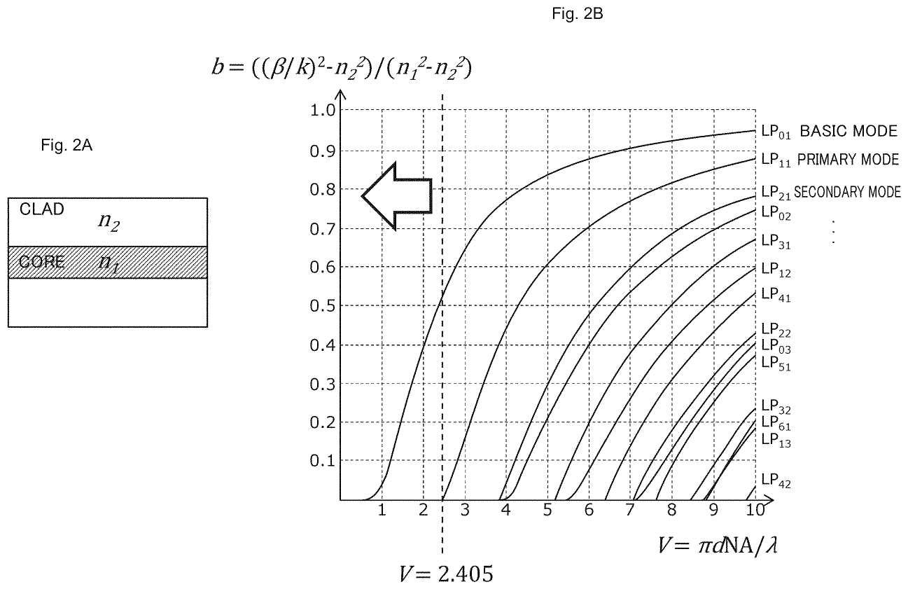

FIG. 2(a) illustrates the basic structure of the optical fiber. The optical fiber has a structure in which a central portion called a core is covered with a layer called a clad. In this case, a refractive index n1 of the core is set high, whereas a refractive index n2 of the clad is set low. Light propagates while being trapped in the core.

FIG. 2(b) indicates an Lpm1 (Linearly Polarized) mode of a step-index optical fiber and a normalized propagation constant b as the function of a normalized frequency V. The vertical axis indicates the normalized propagation constant b. In the absence (interruption) of propagation in a certain mode, b=0 is determined. b approaches 1 as optical power is trapped (propagated) in the core. The horizontal axis indicates the normalized frequency V that can be expressed by formula (1) below. Here, d is a core diameter, NA is a numerical aperture, and λ is a wavelength of light.

$$V = π dNA / λ \qquad ( 1 )$$

For example, LP11 is interrupted when V=2.405 is determined, so that only the mode of LP01 is present. Thus, the single mode is present at V=2.405 or lower. In this case, LP01 is a basic mode (0-th mode) and subsequent LP11, LP21, . . . are denoted as a primary mode, a secondary mode, and the like.

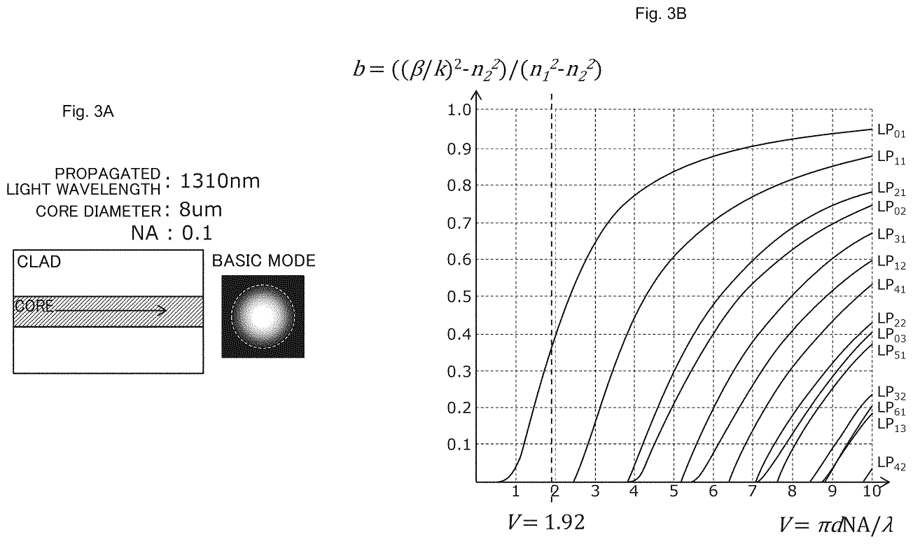

For example, as illustrated in FIG. 3(a), it is assumed that the normalized frequency V is determined in an ordinary case of 1310 nm in the single mode. If the core diameter d and the numerical aperture NA are set at d=8 μm and NA=0.1 that are typical parameters of a 1310-nm optical fiber and light propagates through the fiber at a wavelength of 1310 nm, V=1.92 is obtained from formula (1).

Thus, as indicated in FIG. 3(b), the normalized frequency V is set at 2.405 or lower, allowing propagation only in the basic mode of LP01, that is, in the single mode. The larger the core diameter, the larger the number of modes that allow propagation. In this connection, for example, a typical multimode fiber having a core diameter of 50 μm allows propagation in several hundred modes.

In the case of optical communications through space coupling in FIG. 1, the small core diameter in the single mode results in strict positioning of an optically coupled portion on the transmission side/reception side, which requires high accuracy for correct alignment of an optical axis.

In order to solve this problem, generally, the entry of light into a fiber core is facilitated by using high-precision components or machining an optical input portion connecting to an optical fiber. However, high-precision components are expensive and the need for machining results in high machining cost, so that connectors and systems for single-mode communications generally lead to high cost.

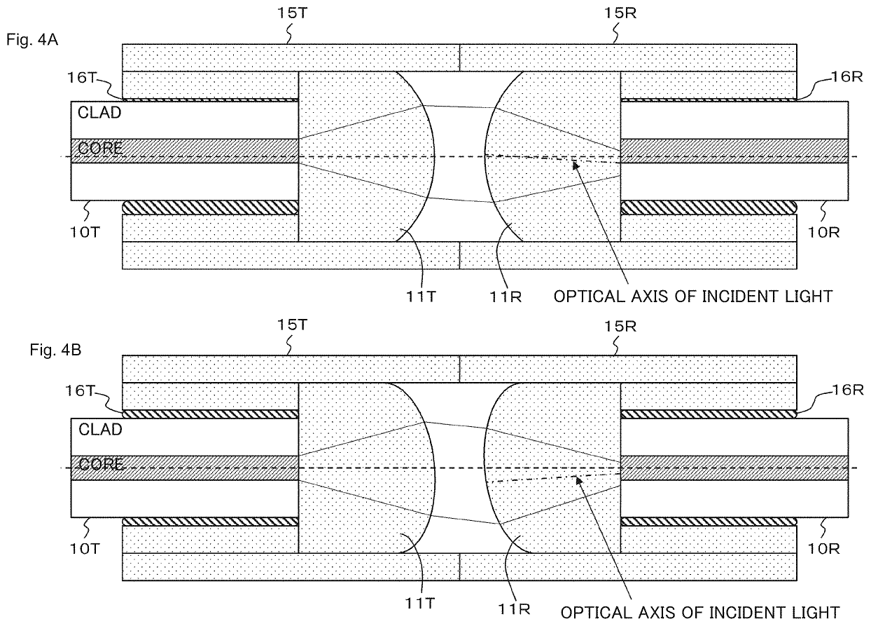

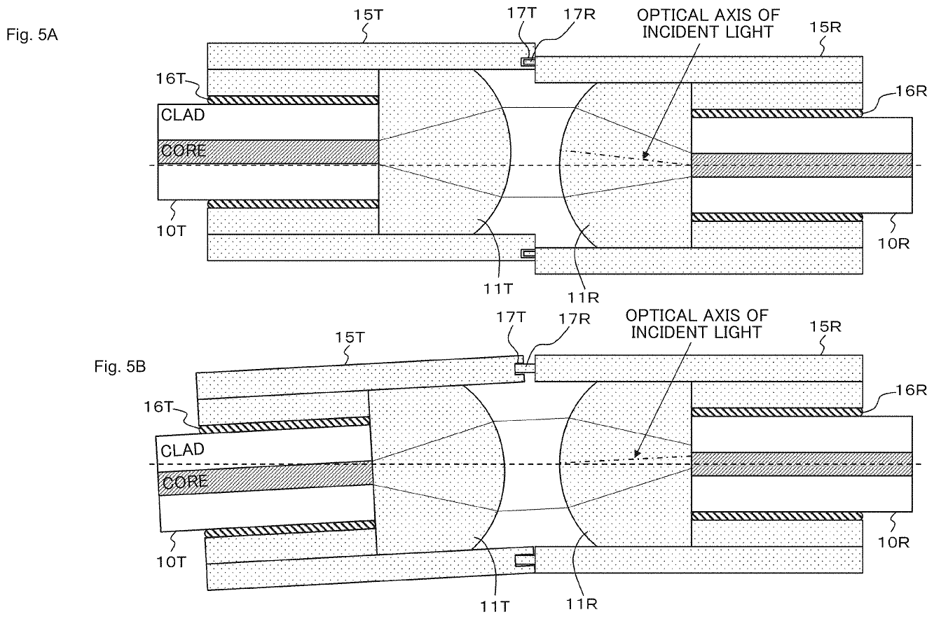

FIGS. 4 and 5 indicate examples of factors responsible for a reduction in the accuracy of optical axis alignment. For example, as illustrated in FIG. 4(a), uneven amounts of fixing materials 16T and 16R for fixing ferrules 15T and 15R and the optical fibers 10T and 10R cause optical axis misalignment. Moreover, for example, insufficient accuracy in shaping the lenses 11T and 11R causes optical axis misalignment as illustrated in FIG. 4(b).

Furthermore, as illustrated in FIGS. 5(a) and 5(b), the insufficient accuracy of positioning mechanisms (a concave portion 17T, a convex portion 17R) provided for the ferrules 15T and 15R causes optical axis misalignment. The convex portion 17R in FIGS. 5(a) and 5(b) may be a pin.

### DESCRIPTION OF EMBODIMENT

The embodiment is configured to reduce cost by relaxing the accuracy optical axis alignment. In the embodiment, an optical fiber allows propagation only in a basic mode at a first wavelength and is configured to perform communications using light with a second wavelength where the optical fiber allows propagation at least in a primary mode as well as the basic mode.

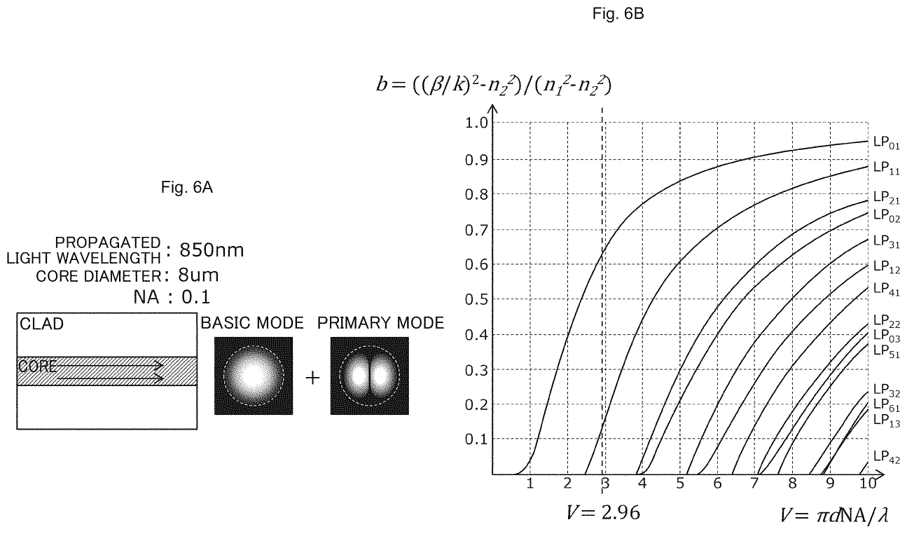

For example, if light with a wavelength of 850 nm instead of 1310 nm is inputted to an optical fiber under the same conditions as FIG. 3(a), the normalized frequency V=2.96 is determined as indicated in FIG. 6(b). Thus, as indicated in FIG. 6(a), the basic mode of LP01 and the primary mode of LP11 can be present.

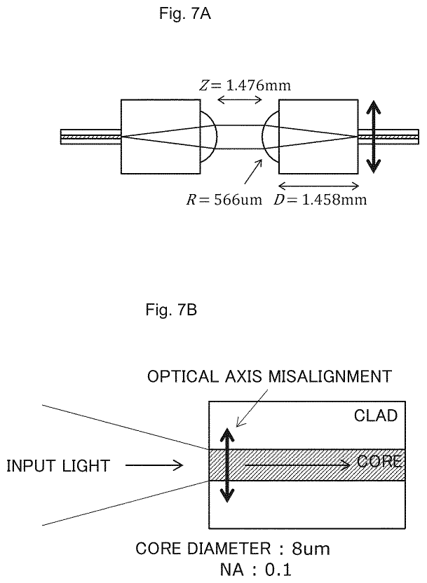

In the following description, it is assumed that when an optical system is configured as illustrated in FIG. 7(a), the position of an optical fiber on the reception side is vertically displaced with respect to the optical axis on condition that only the basic mode of LP01 is present for input light (see arrows in FIGS. 7(a) and 7(b)), that is, optical axis misalignment occurs.

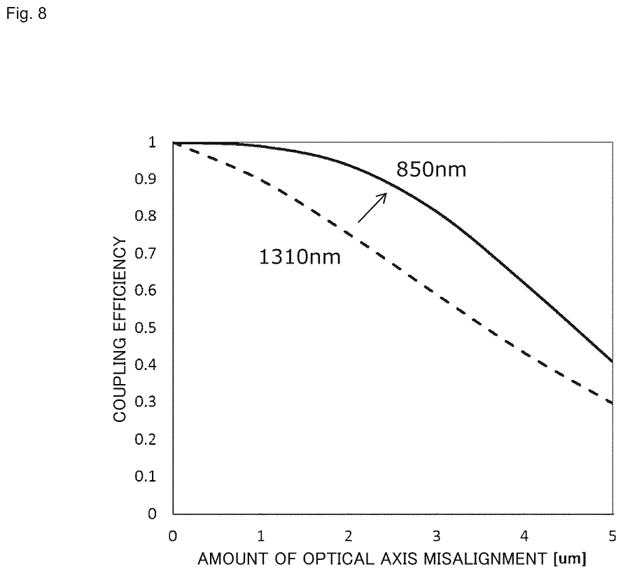

FIG. 8 is a graph indicating the simulation result of coupling efficiency of optical power in such cases. The horizontal axis indicates an amount of optical axis misalignment, and the vertical axis indicates coupling efficiency. In the absence of misalignment, 100% of power propagates through the optical fiber, so that the coupling efficiency is 1. For example, if only 50% of power is propagated through the optical fiber with respect to input power, the coupling efficiency is 0.5.

According to a comparison between 1310 nm and 850 nm, the wavelengths of input light, it is understood that proper characteristics are obtained at 850 nm. This is because propagation is allowed at 1310 nm only in the basic mode while propagation is allowed at 850 nm in the primary mode as well as the basic mode (see FIG. 6(a)).

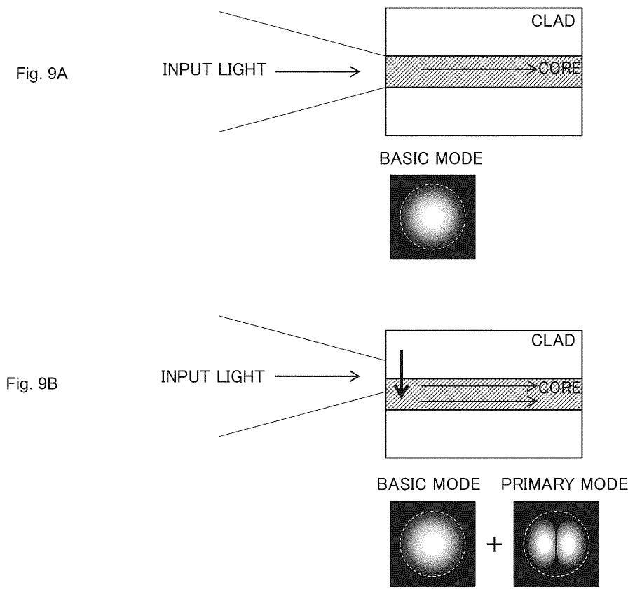

In other words, in the absence of optical axis misalignment, as illustrated in FIG. 9(a), only the basic mode is present for input light. In the presence of optical axis misalignment, as illustrated in FIG. 9(b), the basic mode is partially converted into the primary mode by using a phase difference caused by a difference in refractive index between the clad and the core. Propagation is not allowed at 1310 nm in the primary mode, whereas propagation is allowed at 850 nm also in the primary mode, so that the characteristics improve at 850 nm.

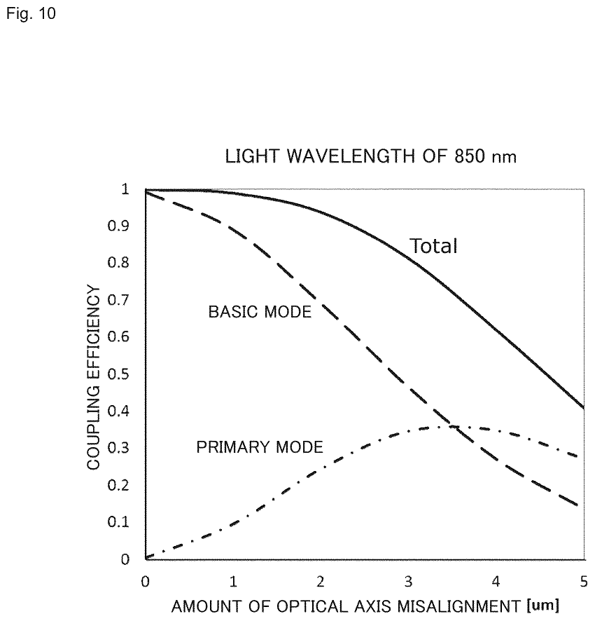

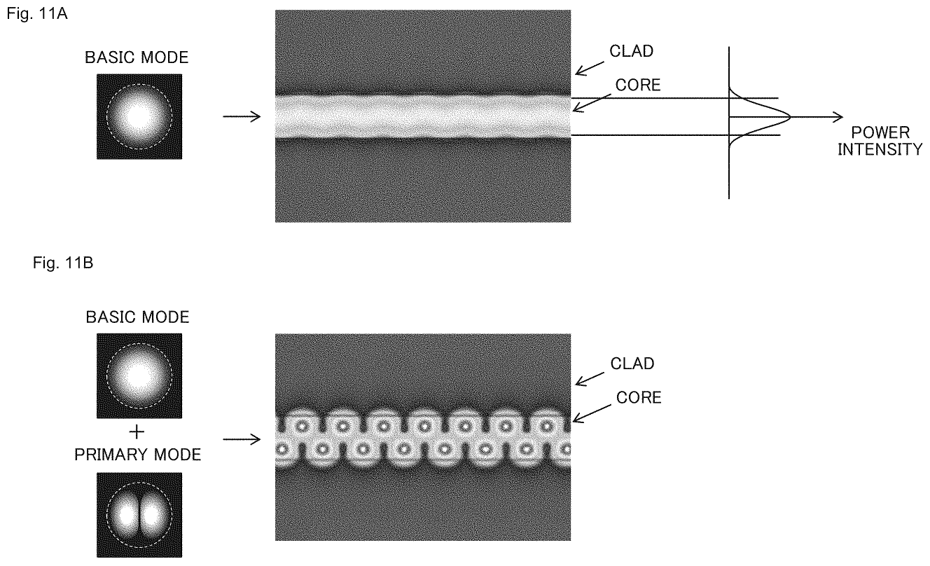

The graph of FIG. 10 indicates a basic mode (zeroth-order mode) component and a primary mode component in a separated manner. A total curve indicates the sum of the components. Only the basic mode is present for input light, proving that the basic mode is converted into the primary mode according to a misalignment. In the case of 1310 nm, propagation is allowed only in the basic mode as indicated in FIG. 3(a), so that the basic mode merely declines as indicated in FIG. 8.

In FIG. 8, according to a comparison between 1310 nm and 850 nm, the accuracy of a misalignment can be relaxed by about 1.8 times with coupling efficiency of 0.8 (about −1 dB) and by about 2.35 times with coupling efficiency of 0.9 (about −0.5 dB).

As described above, the optical fiber allows propagation only in the basic mode at the first wavelength (e.g., 1310 nm) and is configured to perform communications using light with the second wavelength (e.g., 850 nm) where the optical fiber allows propagation at least in the primary mode as well as the basic mode. Thus, the coupling efficiency of optical power can be improved.

In the embodiment, the optical fiber is configured to perform communications using light having at least the components of the primary mode as well as the basic mode.

FIG. 11 indicates simulations on the intensity distribution of light conveyed through the optical fiber. FIG. 11(a) indicates an example of the transmission of light having only the components of the basic mode. In this case, the intensity is maximized at the center of the core of the optical fiber and decreases toward the clad. FIG. 11(b) indicates an example of the transmission of light having the components of the basic mode and the primary mode. In this case, points having high intensity alternately appear in one direction and another direction with respect to the center of the core, that is, upward and downward in the illustrated examples.

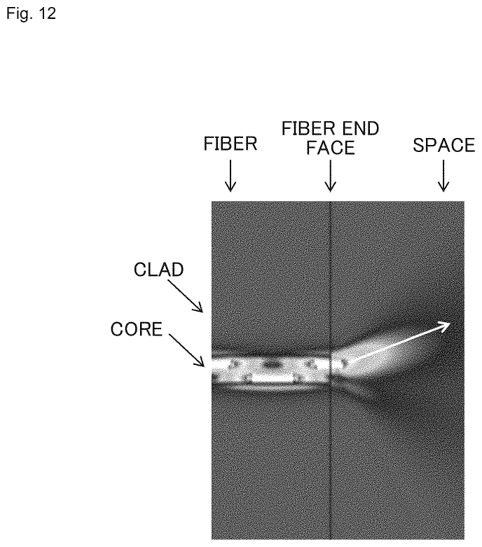

In the state of FIG. 11(b), when light is emitted from a fiber end face as shown in FIG. 12, the light travels at a certain angle toward the point with high intensity with respect to the center of the core.

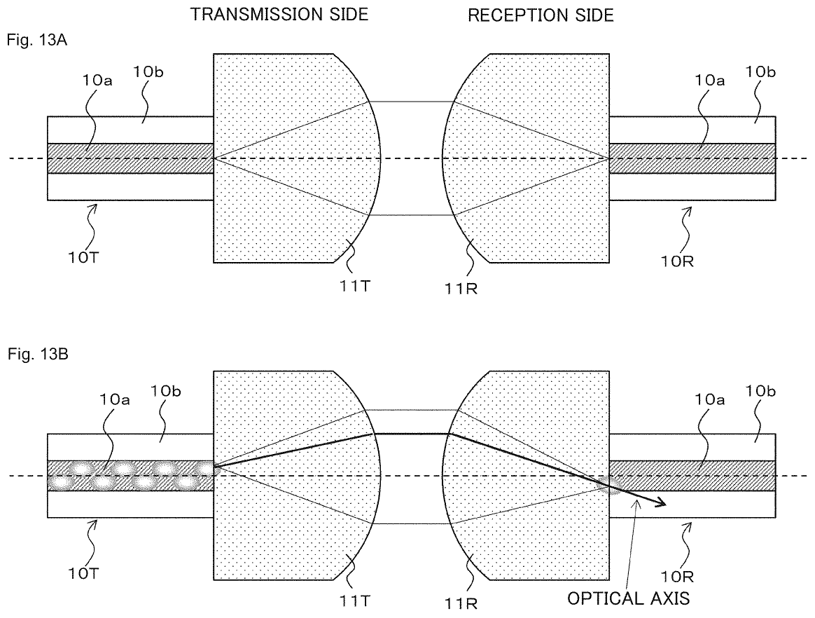

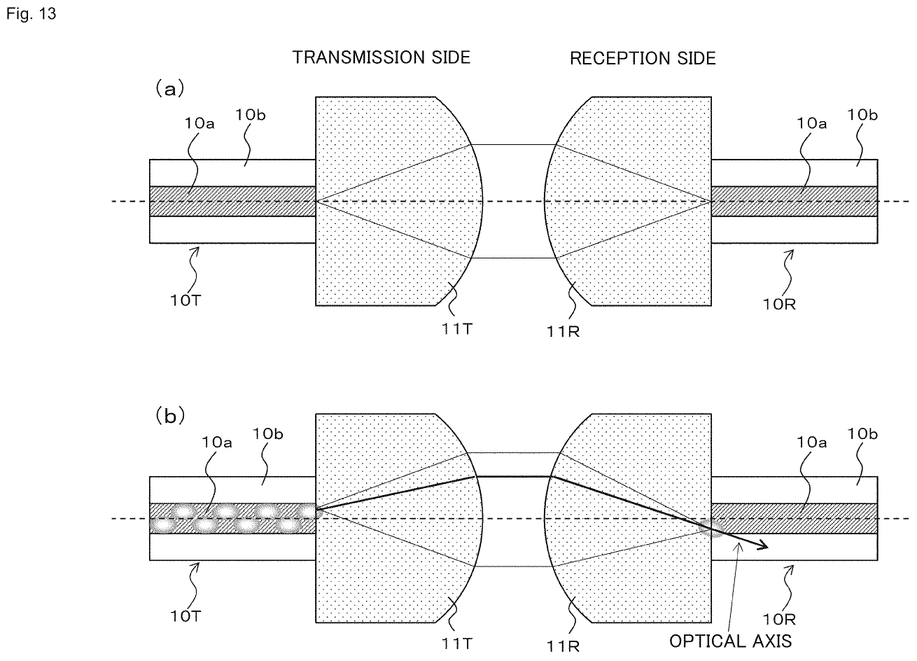

Optical communications through spatial coupling shown in FIG. 1 will be described below. As illustrated in FIG. 13(a), light emitted from the center of the core 10a on the transmission side is coupled to the center of the core 10a on the reception side. However, as illustrated in FIG. 13(b), in the case where light including the components of the basic mode and the primary mode is transmitted, light with an intensity distribution biased upward from the center of the core 10a on the transmission side is coupled downward with respect to the center of the core 10a on the reception side.

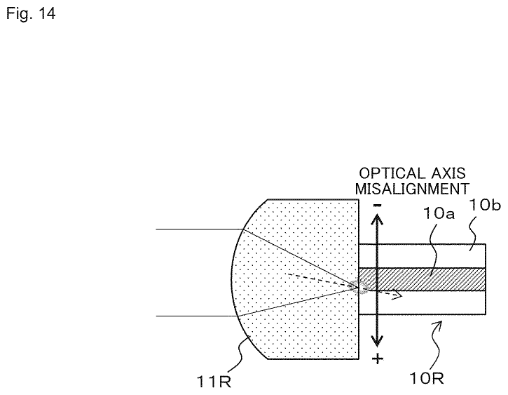

It is assumed that an optical axis misalignment occurs under the conditions of FIG. 13(b) such that the position of the optical fiber 10R on the reception side is vertically shifted with respect to the lens 11R as illustrated in FIG. 14. In this case, the amount of optical axis misalignment is zero in the illustrated state. In the case of an optical axis misalignment in positive (+) direction, the point having high light intensity is directed to enter the core 10a of the optical fiber 10R, thereby facilitating coupling. In the case of an optical axis misalignment in negative (−) direction, the core 10a of the optical fiber 10R moves opposite to the traveling direction of light, thereby reducing coupling efficiency.

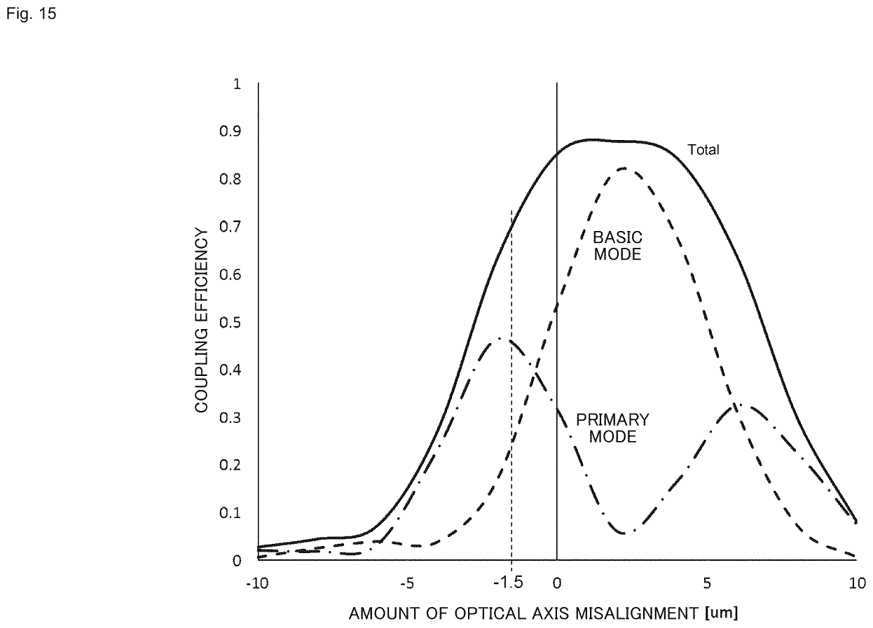

FIG. 15 is a graph of a simulation result on the coupling efficiency of optical power if input light (light emitted from the transmission side) includes the components of the basic mode and the primary mode with the ratio of 1 to 1. The horizontal axis indicates an amount of optical axis misalignment, and the vertical axis indicates coupling efficiency. In the illustrated example, a basic mode (zeroth-order mode) component and a primary mode component are indicated in a separated manner. A total curve indicates the sum of the components. In the presence of only the basic mode, the coupling efficiency considerably decreases when a misalignment occurs in negative (−) direction. Since the basic mode is converted into the primary mode, the amount of misalignment is −1.5 μm and the coupling efficiency is about 0.7.

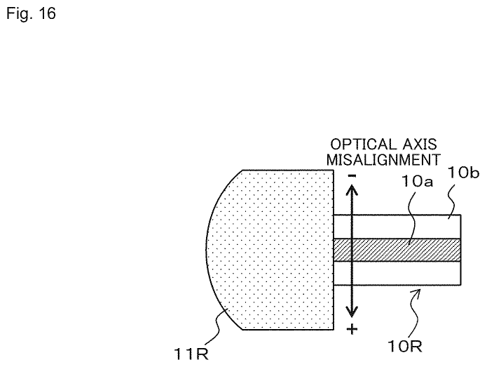

In optical communications through spatial coupling as shown in FIG. 13, it is assumed that the position of the optical fiber 10R on the reception side is vertically shifted with respect to the lens 11R as illustrated in FIG. 16 in the case where input light (light emitted from the transmission side) includes only basic mode components and the case where the basic mode and the primary mode are present.

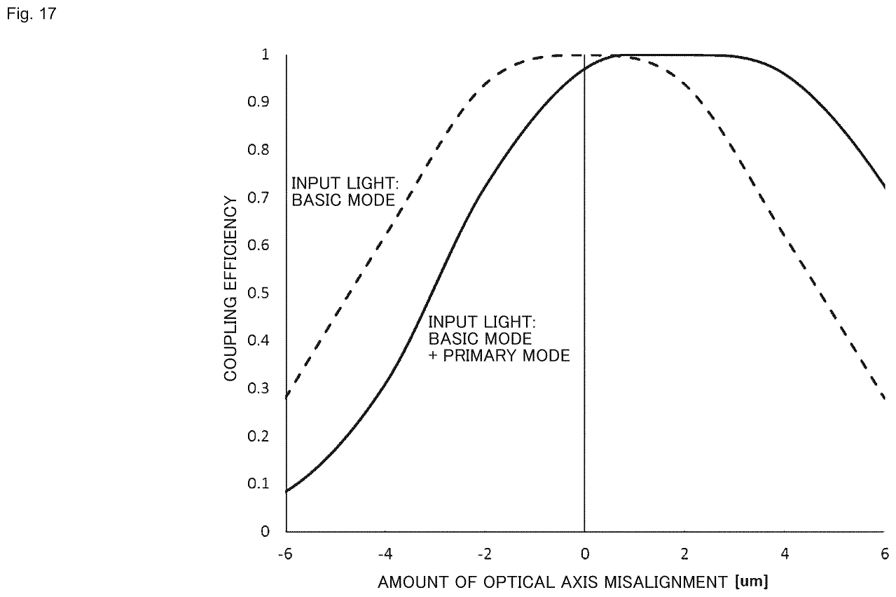

FIG. 17 is a graph indicating the simulation result of coupling efficiency of optical power in the case where input light includes only the components of the basic mode and the case where input light includes the components of the basic mode and the primary mode. The horizontal axis indicates an amount of optical axis misalignment, and the vertical axis indicates coupling efficiency. In the graph, to obtain a uniform criterion, the coupling efficiency of the point having the maximum intensity is set at 1 as a standard.

If input light includes the components of the basic mode and the primary mode, an optical axis misalignment in positive (+) direction leads to higher coupling efficiency than in the case where input light includes only the components of the basic mode. This is because, as described above, the point having high light intensity is directed to enter the core 10a of the optical fiber 10R and thus facilitates coupling when an optical axis misalignment occurs in positive (+) direction.

However, if input light includes the components of the basic mode and the primary mode, an optical axis misalignment in negative (−) direction leads to lower coupling efficiency than in the case where input light includes only the components of the basic mode. This is because, as described above, the core 10a of the optical fiber 10R moves opposite to the traveling direction of light.

In the configuration where communications are performed using light including at least the components of the primary mode as well as the basic mode, the coupling efficiency of optical power can be improved as compared with that in communications using light including the components of the basic mode, depending upon the direction of an optical axis misalignment. In this case, the configuration is designed to accept an axis misalignment of the optical fiber only in the same direction as the traveling direction of input light. Thus, input light including the components of the basic mode and the primary mode is more resistant to an axis misalignment than input light including only the components of the basic mode.

Furthermore, in the embodiment, in order to improve the coupling efficiency of optical power for an optical axis misalignment in negative (−) direction in the case of communications performed using light including the components of the primary mode as well as the basic mode, an optical path adjusting unit is provided to adjust an optical path such that input light is guided to the core of an optical waveguide.

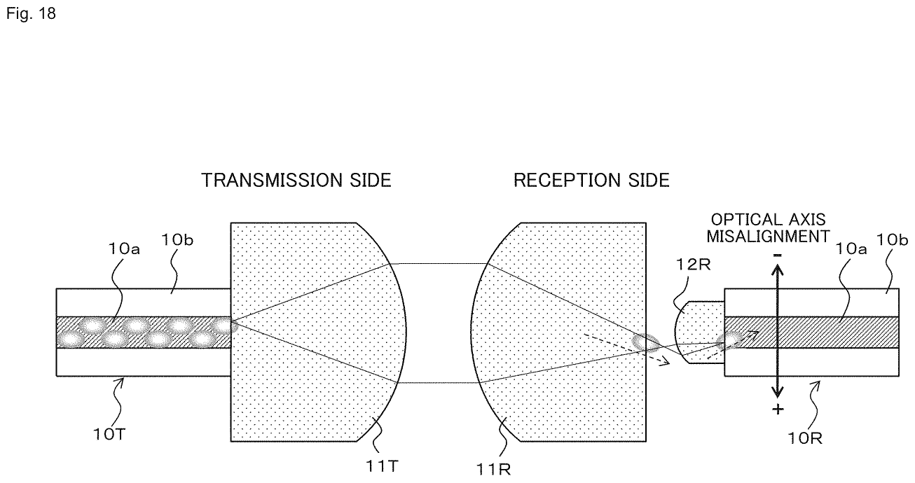

FIG. 18 illustrates an example in which a convex lens 12R is provided as the optical path adjusting unit on the entry side of the optical fiber 10R. Since the convex lens 12R is provided, light deviating downward with respect to the optical axis can be returned to the central direction of the optical axis by using a lens effect. Thus, the coupling efficiency of optical power can be improved for an optical axis misalignment in negative (−) direction.

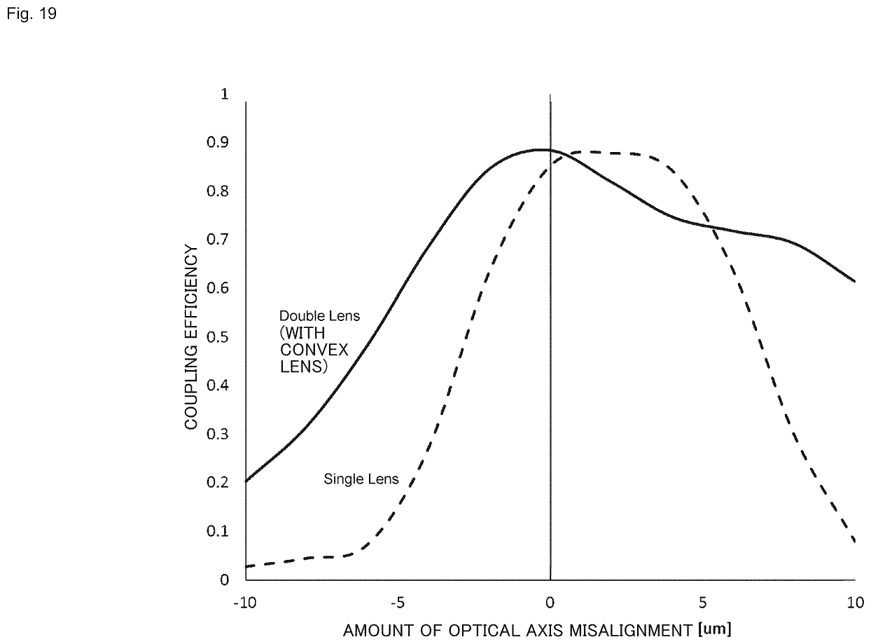

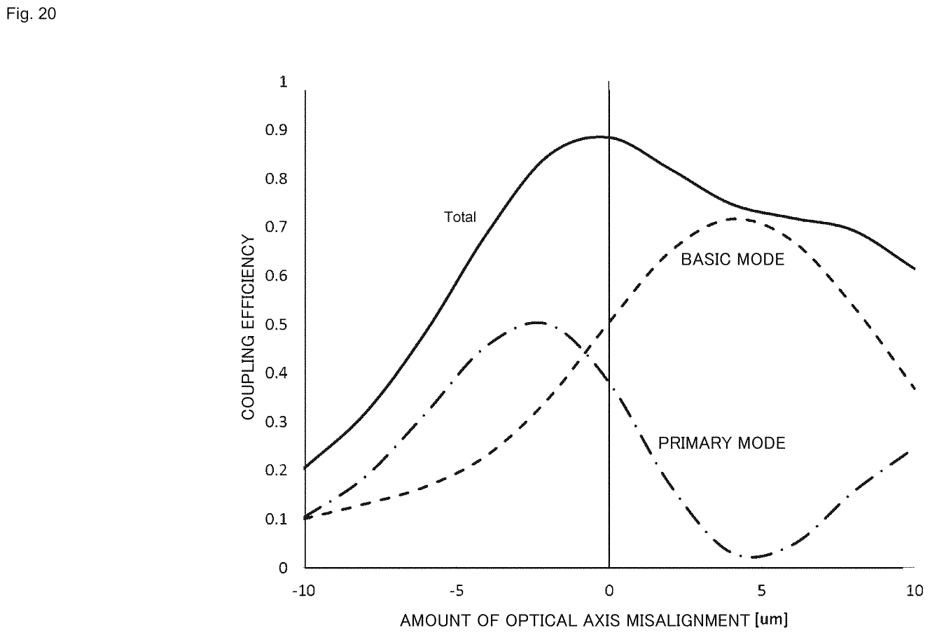

FIG. 19 is a graph of a simulation result on the coupling efficiency of optical power in the case of a double lens including the convex lens 12R and a single lens not including the convex lens 12R. The horizontal axis indicates an amount of optical axis misalignment, and the vertical axis indicates coupling efficiency. For an optical axis misalignment in negative (−) direction, the double lens has higher coupling efficiency than the single lens. In the graph of FIG. 20, a basic mode (zeroth-order mode) component and a primary mode component are indicated in a separated manner when the convex lens 12R is provided. A total curve indicates the sum of the components.

For an optical axis misalignment in negative (−) direction, the double lens has higher coupling efficiency than the single lens because of the following effects: the effect of obtaining a smaller loss in the basic mode than the single lens because light is directed, even when the optical fiber 10R is shifted in negative (−) direction, to the central direction of the fiber by returning the light to the optical axis direction, and the effect of increasing the ratio of the basic mode to be converted into the primary mode. In a comparison with coupling efficiency of 0.7, the single lens has a misalignment of −1.5 μm, whereas the double lens has a misalignment of −4 μm, proving that the accuracy can be relaxed by 2.7 times. Thus, the accuracy can be more relaxed by the double lens, thereby reducing the cost of components.

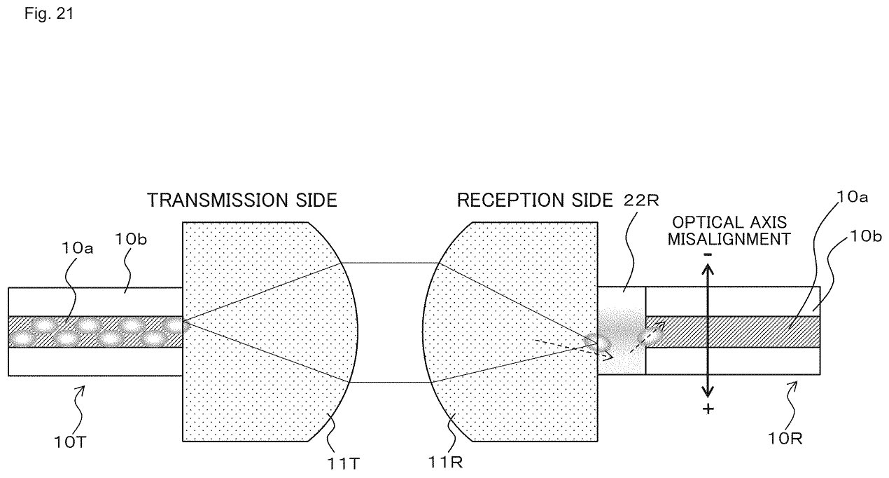

FIG. 21 illustrates an example in which a GRIN lens (Gradient index lens) 22R serving as the optical path adjusting unit is provided on the entry side of the optical fiber 10R. The GRIN lens 22R is a member having a refractive index distribution. The GRIN lens 22R has the same refractive index as, for example, the core 10a of the optical fiber 10R on the optical axis and has a gradation structure in which a refractive index decreases in the vertical direction from the optical axis.

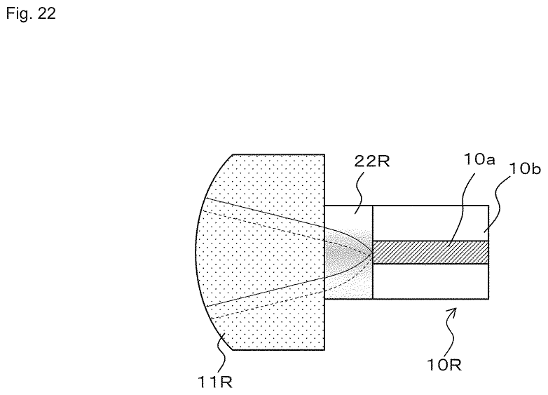

The GRIN lens 22R is provided thus on the entry side of the optical fiber 10R, so that light entering the GRIN lens 22R travels while being bent in the optical axis direction by a gradation effect. Even if an optical axis misalignment occurs, the light can be returned to the central direction. The reason is that when an optical path is shifted downward with respect to the optical axis as indicated by a broken line in FIG. 22, light around the optical axis has a small difference in refractive index and thus has a small amount of bending and light deviating from the optical axis has a large difference in refractive index and thus has a large amount of bending, so that light gathers around the center of the core 10a. This can increase the coupling efficiency of optical power for an optical axis misalignment in negative (−) direction as in the provision of the convex lens 12R.

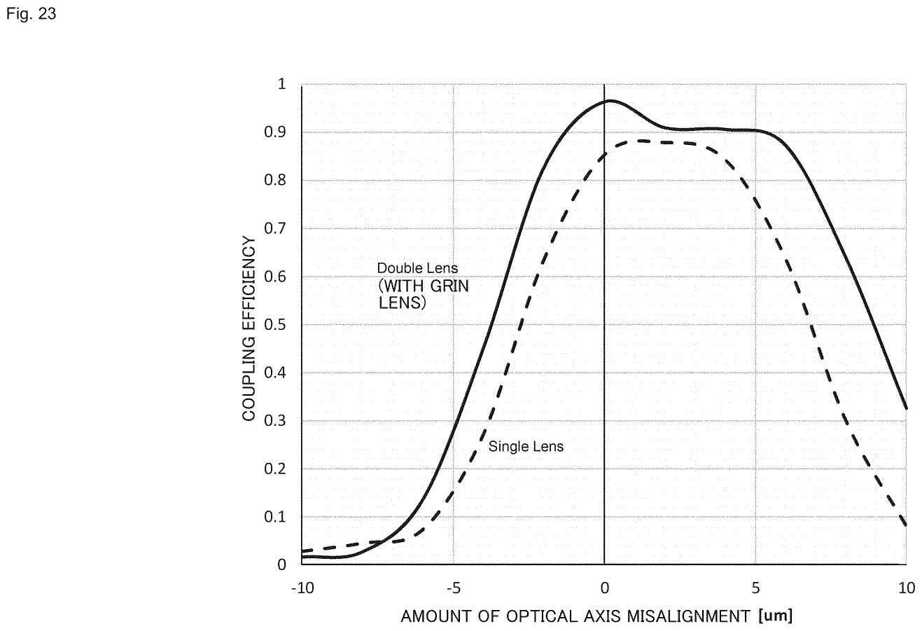

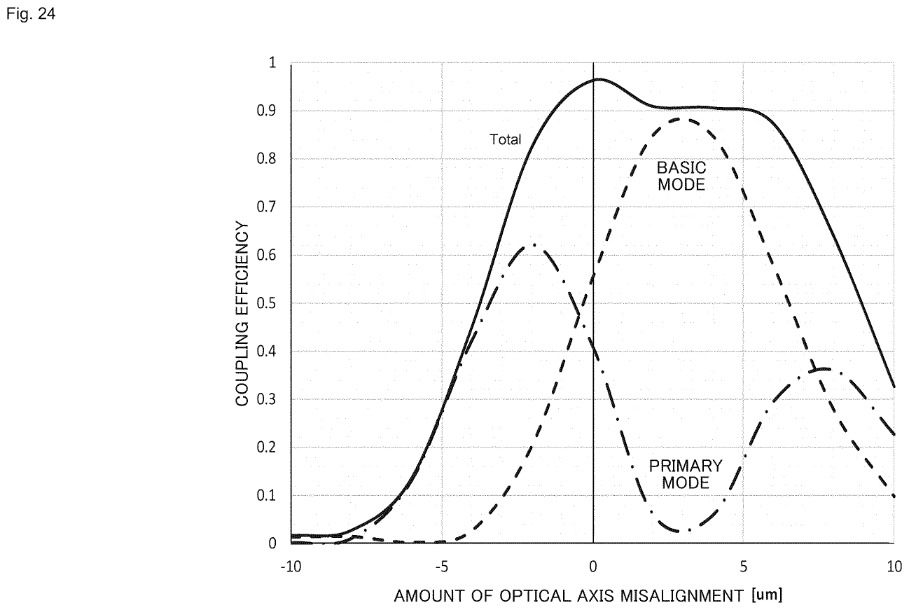

FIG. 23 is a graph of a simulation result on the coupling efficiency of optical power in the case of a double lens including the GRIN lens 22R and a single lens not including the GRIN lens 22R. The horizontal axis indicates an amount of optical axis misalignment, and the vertical axis indicates coupling efficiency. For example, if the GRIN lens 22R is provided for an optical axis misalignment in negative (−) direction, the double lens has higher coupling efficiency than the single lens. In the graph of FIG. 24, a basic mode (zeroth-order mode) component and a primary mode component are indicated in a separated manner when the GRIN lens 22R is provided. A total curve indicates the sum of the components.

If the lens (convex lens 12R or GRIN lens 22R) as the optical path adjusting unit is provided on one end of the optical fiber 10 on the reception side as described above, the influence of aberration of light can be minimized as an optical design by placing the lens as the optical path adjusting unit on both of the transmission side and the reception side. Thus, the same lens needs to be provided on one end of the optical fiber 10T on the transmission side.

An example of the GRIN lens provided on one end of the optical fiber will be described below. The same is true in the provision of a convex lens or a lens having other similar functions on one end of an optical fiber. A detailed description thereof is omitted.

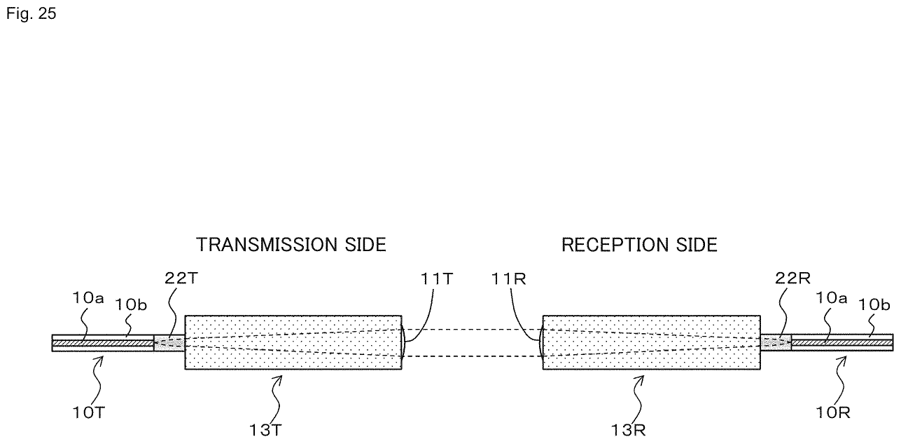

FIG. 25 illustrates an example in which the GRIN lens 22R serving as the optical path adjusting unit is provided on the reception side and an identical GRIN lens 22T is provided on the transmission side. In this case, the lens 11T on the transmission side is machined and shaped on the output end side of a lens member 13T made of, for example, a resin. The GRIN lens 22T is disposed on the output end portion of the optical fiber 10T and thus is interposed between the optical fiber 10T and the lens member 13T. The lens 11R on the reception side is machined and shaped on the input end side of a lens member 13R made of, for example, a resin. The GRIN lens 22R is disposed on the incident end portion of the optical fiber 10R and thus is interposed between the optical fiber 10R and the lens member 13R.

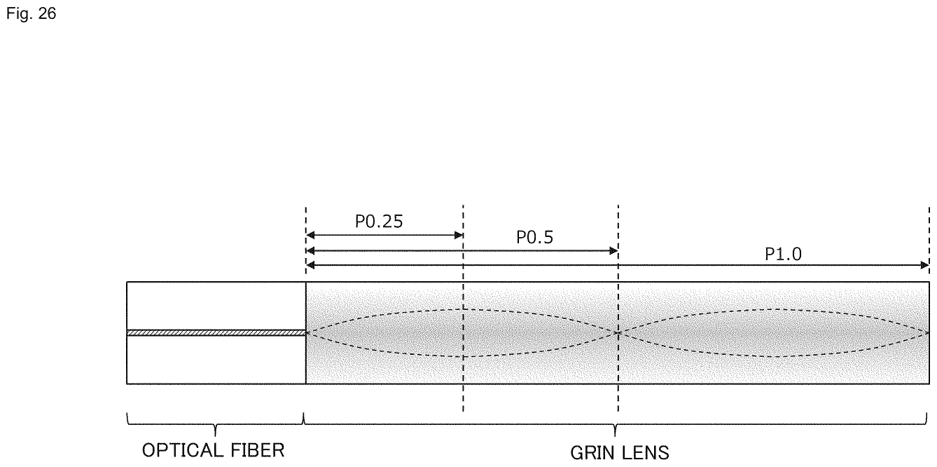

FIG. 26 is an explanatory drawing of the GRIN lens. The GRIN lens is a member having a refractive index distribution. The GRIN lens has a gradation structure in which a refractive index is maximized at the center of the optical axis and decreases toward the outside.

As indicated by broken lines, light outputted from the optical fiber spreads, in the GRIN lens, in a diffusion direction but travels in a focusing direction from a certain point. The light travels while repeating these steps. A distance to the first widest point is denoted as a pitch 0.25 (P0.25), a distance to the first light collection is denoted as a pitch 0.5 (P0.5), and a distance to the second light collection from the second diffusion is denoted as a pitch 1.0 (P1.0).

In a system where light is collimated through a collimating lens, light emitted from a GRIN lens needs to be projected in a diffusion direction, so that a pitch of 0.25 or less is basically required to be used. Additionally, pitches including 1.0 to 1.25 and 2.0 to 2.25 may be used.

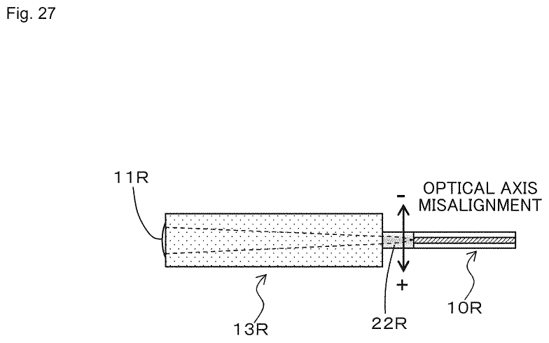

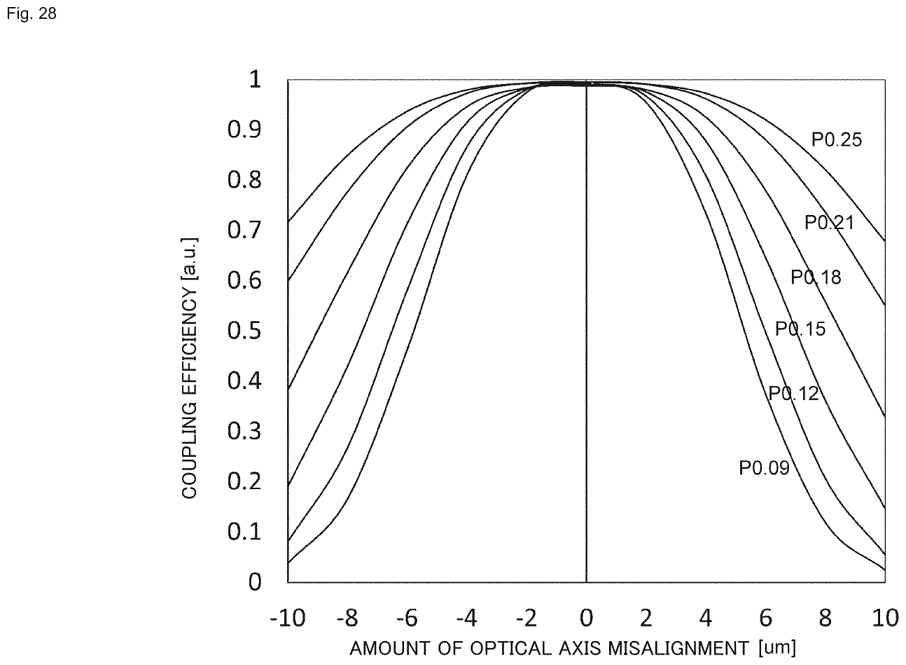

As illustrated in FIG. 27, it is assumed that an optical axis misalignment occurs such that the positions of the optical fiber 10R and the GRIN lens 22R on the reception side are vertically shifted with respect to the lens 11R. FIG. 28 is a graph indicating the simulation results of resistance to an optical axis misalignment when pitches are changed, that is, the coupling efficiency of optical power. The horizontal axis indicates an amount of optical axis misalignment, and the vertical axis indicates coupling efficiency. As shown in FIG. 28, P0.25 has a smaller loss with respect to an axis misalignment. The loss tends to increase as the pitch decreases. Thus, the pitch is desirably set close to 0.25.

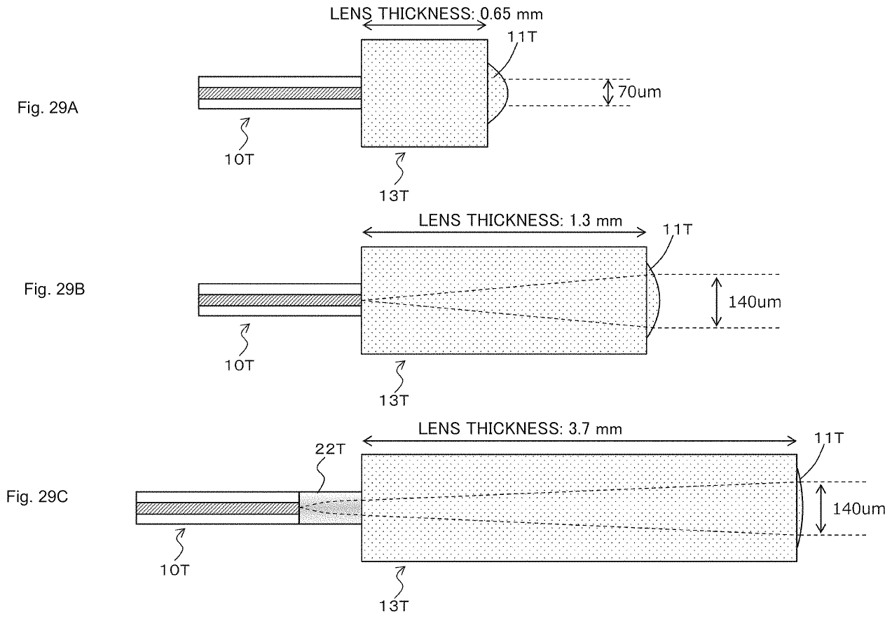

FIG. 29 indicates examples of the thickness (lens thickness) of the lens member 13T on the transmission side. FIG. 29(b) illustrates the case where the GRIN lens 22T is absent. FIG. 29(c) illustrates the case where the GRIN lens 22T is present.

The diameter of a collimated light beam is desirably increased to allow communications even if dirt or dust adheres to a portion irradiated with a collimated light beam. The examples of FIGS. 29(b) and 29(c) indicate the thicknesses (lens thicknesses) of the lens member 13T when the diameter of a collimated light beam is set at 140 μm. As illustrated in FIG. 29(a), when the diameter of a collimated light beam is reduced to about 70 μm, a physical transmission distance to the desired diameter of 70 μm of the collimated light beam is shortened with respect to an angle of output from the optical fiber 10T. Thus, the thickness (lens thickness) of the lens member 13T decreases.

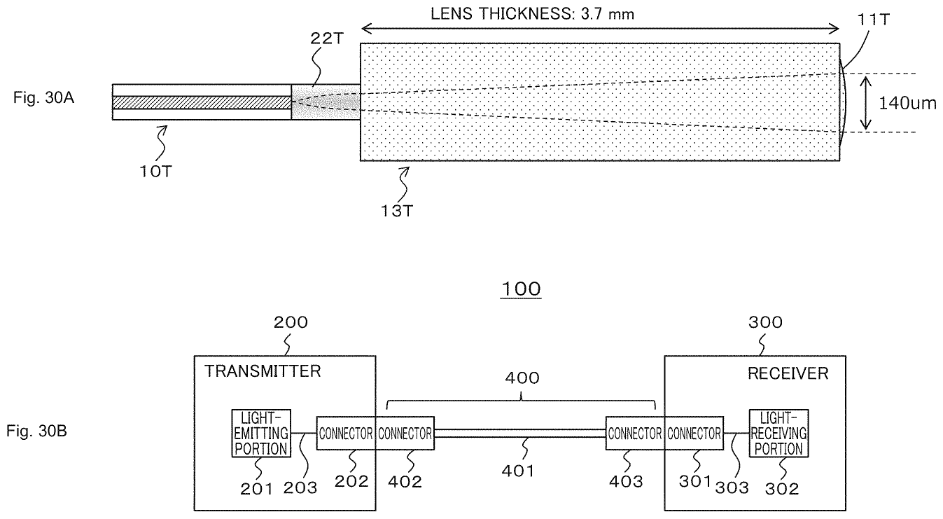

Unfortunately, a larger thickness (lens thickness) of the lens member 13T may increase an amount of optical loss. As illustrated in FIG. 30(a), for example, when the diameter of a collimated light beam is to be set at 140 μm using the GRIN lens 22T of P0.25, the thickness (lens thickness) of the lens member 13T, that is, a distance between the GRIN lens 22R and the lens 11T is 3.7 mm.

If the lens member 13T is a resin member, impurities are typically mixed with the material to improve hardness and workability, so that the transmittance is about 80% to 90%. As the lens member 13T, a material with substantially 100% transmittance, for example, a glass member can also be used. However, the workability of the part of the lens member 13T becomes lower than that of resin, leading to additional cost. Although a resin member is more preferably used in terms of cost, the use of the resin member may increase an amount of optical loss. For example, when light travels for a distance of 3.7 mm, a loss of about 2 dB occurs at 90%/mm.

An optical communication system 100 illustrated in FIG. 30(b) will be described below. The optical communication system 100 includes a transmitter 200, a receiver 300, and a cable 400. The transmitter 200 is, for example, an AV source such as a personal computer, a game console, a disc player, a set-top box, a digital camera, or a mobile phone. The receiver 300 is, for example, a television receiver or a projector. The transmitter 200 and the receiver 300 are connected to each other via the cable (optical cable) 400.

The transmitter 200 includes a light-emitting portion 201, a connector (optical connector) 202 as a receptacle, and an optical fiber 203 that propagates, to the connector 202, light emitted by the light-emitting portion 201. The light-emitting portion 102 includes a laser element such as a VCSEL (Vertical Cavity Surface Emitting LASER) or a light-emitting element such as an LED (light-emitting diode). The light-emitting portion 201 converts an electric signal (transmitting signal) generated by a transmitting circuit, which is not illustrated, into an optical signal. The optical signal emitted by the light-emitting portion 201 is propagated to the connector 202 through the optical fiber 203.

The receiver 300 also includes a connector 301 as a receptacle, a light-receiving portion 302, and an optical fiber 303 that propagates light obtained at the connector 301 to the light-receiving portion 302. The light-receiving portion 302 includes a light-receiving element such as a photodiode. The light-receiving portion 302 converts an optical signal transmitted from the connector 301 into an electric signal (receiving signal) and supplies the electric signal to a receiving circuit, which is not illustrated.

The cable 400 is configured to with connectors (optical connectors) 402 and 403 as plugs at one end and the other end of an optical fiber 401. The connector 402 at one end of the optical fiber 401 is connected to the connector 202 of the transmitter 200, and the connector 403 at the other end of the optical fiber 401 is connected to the connector 301 of the receiver 300.

In view of the overall optical communication system 100, at least four points have a structure illustrated in FIG. 30(a) and the total amount of optical loss is about 8 dB, which is not a negligible amount of loss. The four points are the connector 202 of the transmitter 200, the connector 301 at the receiver 300, and the connectors 402 and 403 of the cable 400.

Unfortunately, the amount of optical loss similarly increases also in the absence of the GRIN lens 22T as illustrated in FIG. 29(b). Also in this case, the amount of optical loss is not negligible in the overall communication system 100. Therefore, the diameter of a collimated light beam cannot be increased, to be specific, the structure of FIG. 29(a), in which the diameter of a collimated light beam is reduced, is used for typical single-mode communications.

If a resin member is used as the lens member as described above, the lens thickness (the thickness of the lens member) cannot be increased due to the influence of transmittance. Thus, a distance from the optical fiber to the lens cannot be extended, leading to difficulty in increasing the diameter of a collimated light beam.

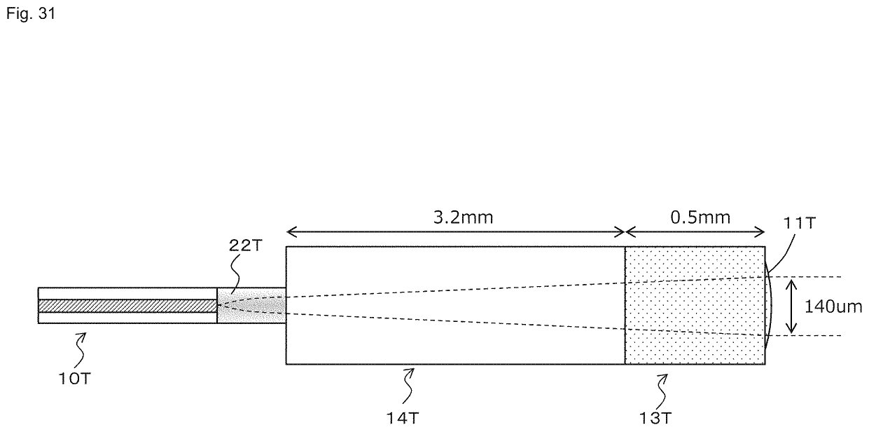

In the present embodiment, as illustrated in FIG. 31, a high-transmittance portion 14T having a higher transmittance than the lens member 13T is disposed between the GRIN lens 22T and the lens member 13T. For example, the lens member 13T is configured with a resin member, whereas the high-transmittance portion 14T is configured with a glass member.

When the high-transmittance portion 14T is disposed thus, even if a distance from the optical fiber 10T to the lens 11T is increased, a lens thickness (the thickness of the lens member 13T) can be suppressed and the amount of optical loss through the lens member 13T can be reduced, thereby securing a diameter of a collimated light beam with a small amount of loss.

In the structure illustrated in FIG. 31, the lens member 13T has a thickness of 0.5 mm. The thickness is set in consideration of the hardness and workability of the resin member serving as the lens member 13T and is not limited to this value. A member constituting the high-transmittance portion 14T, for example, a glass member merely acts as a spacer and is inexpensively available without lens processing.

The structure in FIG. 31 illustrates the part of the connector 202 of the transmitter 200 in the communication system 100 illustrated in FIG. 30. The parts of the connector 301 of the receiver 300 and the connectors 402 and 403 of the cable 400 also have similar structures.

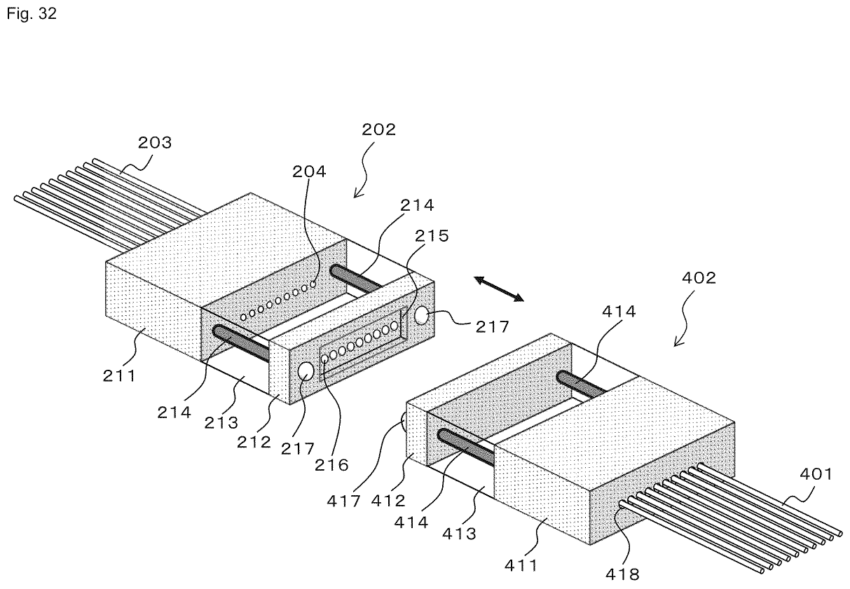

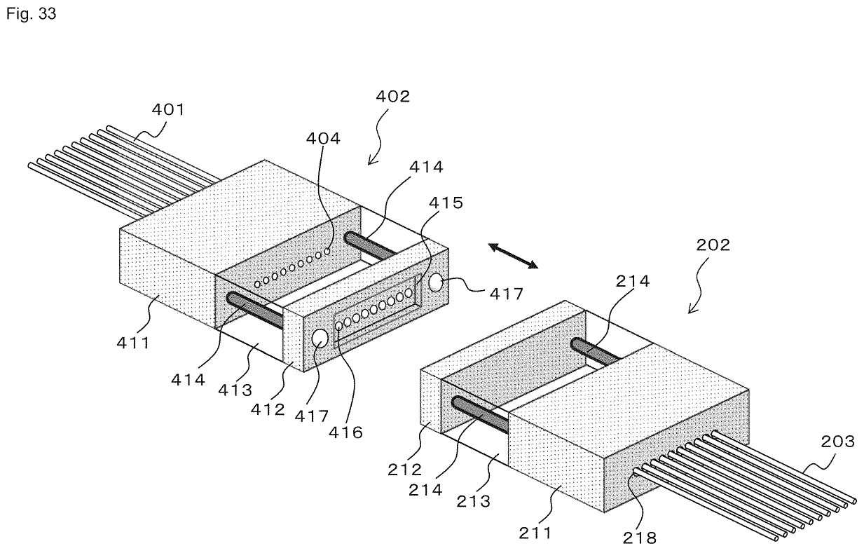

FIG. 32 is a perspective view illustrating a configuration example of the connector 202 of the transmitter 200 and the connector 402 of the cable 400. FIG. 33 is also a perspective view illustrating a configuration example of the connector 202 of the transmitter 200 and the connector 402 of the cable 400, but the view is taken in a direction opposite to FIG. 32. The illustrated example corresponds to the parallel transmission of optical signals of multiple channels. Although FIG. 33 illustrates the example corresponding to the parallel transmission of optical signals of multiple channels, an example corresponding to the transmission of an optical signal of one channel can be similarly configured.

The connector 202 includes a connector body (ferrule) 211 that is configured with a resin member and has a cuboid appearance. The connector body 211 is configured with, for example, a resin member or a glass member. On the backside of the connector body 211, the plurality of optical fibers 203 for the respective channels are connected while being arranged in the horizontal direction. Each of the optical fibers 203 is fixed with the distal end side inserted into an optical-fiber insertion hole 218 and the distal end in contact with a GRIN lens 204. In this case, at the front side of the connector body 211, the GRIN lenses 204 are exposed in contact with the optical fibers 203.

Moreover, the connector 202 includes a lens member 212 having a substantially cuboid appearance. The lens member 212 is configured with a resin member. At the front side of the lens member 212, a concave light-emitting portion (light transmission space) 215 having a rectangular opening is formed. At the bottom portion of the light-emitting portion 215, a plurality of lenses (convex lenses) 216 are formed for the respective channels while being arranged in the horizontal direction. This can prevent the surface of the lens 216 from accidentally hitting and damaging a counterpart connector or the like.

Moreover, at the front side of the lens member 212, convex or concave position regulating portions 217 for alignment with the connector 402 are integrally formed. The position regulating portions 217 are formed concavely in the illustrated example. This facilitates optical axis alignment in connection to the connector 402.

The connector 202 further includes a high-transmittance portion 213 having a cuboid appearance. The high-transmittance portion 213 is configured with a glass member having a higher transmittance than the lens member 212. The high-transmittance portion 213 is disposed between the connector body 211 and the lens member 212 and acts as a spacer. Thus, even if the lens thickness (the thickness of the lens member 212) is suppressed, a necessary length is ensured as a distance between one end of the optical fiber 203 and the lens 216 serving as a collimator lens, thereby increasing the diameter of a collimated light beam.

Optical axis alignment between the cores of the optical fibers 203 for the channels and the lenses 216 for the channels is performed by positioning pins 214, the optical fibers 203 being held by the connector body 211, the lenses 216 being machined and formed on the lens member 212. The positioning pin 214 penetrates the high-transmittance portion 213 and has both ends connected to the connector body 211 and the lens member 212. In this case, the positions of the plurality of optical-fiber insertion holes 218 formed on the connector body 211 and the plurality of lenses 216 formed on the lens member 212 are designed with respect to the connection positions of the positioning pins 214.

The connector 402 is configured like the connector 202. Specifically, the connector 402 includes a connector body (ferrule) 411 that is configured with a resin member and has a cuboid appearance. The connector body 411 is configured with, for example, a resin member or a glass member. On the backside of the connector body 411, the plurality of optical fibers 401 for the respective channels are connected while being arranged in the horizontal direction. Each of the optical fibers 401 is fixed with the distal end side inserted into an optical-fiber insertion hole 418 and the distal end in contact with a GRIN lens 404. In this case, at the front side of the connector body 411, the GRIN lenses 404 are exposed in contact with the optical fibers 401.

Moreover, the connector 402 includes a lens member 412 having a substantially cuboid appearance. The lens member 412 is configured with a resin member. At the front side of the lens member 412, a concave light incident portion (light transmission space) 415 having a rectangular opening is formed. At the bottom portion of the light incident portion 415, a plurality of lenses (convex lenses) 416 are formed for the respective channels while being arranged in the horizontal direction. This can prevent the surface of the lens 416 from accidentally hitting and damaging a counterpart connector or the like.

Moreover, at the front side of the lens member 412, convex or concave position regulating portions 417 for alignment with the connector 402 are integrally formed. The position regulating portions 417 are formed concavely in the illustrated example. This facilitates optical axis alignment in connection to the connector 202. The position regulating portions 417 are not always formed integrally on the lens member 412. Pins may be used instead or other techniques may be performed.

The connector 402 further includes a high-transmittance portion 413 having a cuboid appearance. The high-transmittance portion 413 is configured with a member having a higher transmittance than the lens member 412, for example, a glass member. The high-transmittance portion 413 is disposed between the connector body 411 and the lens member 412 and acts as a spacer. Thus, even if the lens thickness (the thickness of the lens member 412) is suppressed, a certain length is ensured as a distance between one end of the optical fiber 401 and the lens 416 serving as a condenser lens, thereby increasing the diameter of a collimated light beam.

Optical axis alignment between the cores of the optical fibers 401 for the channels and the lenses 416 for the channels is performed by positioning pins 414, the optical fibers 401 being held by the connector body 411, the lenses 416 being machined and formed on the lens member 412. The positioning pin 414 penetrates the high-transmittance portion 413 and has both ends connected to the connector body 411 and the lens member 412. In this case, the positions of the plurality of optical-fiber insertion holes 418 formed on the connector body 411 and the plurality of lenses 416 formed on the lens member 412 are designed with respect to the connection positions of the positioning pins 414.

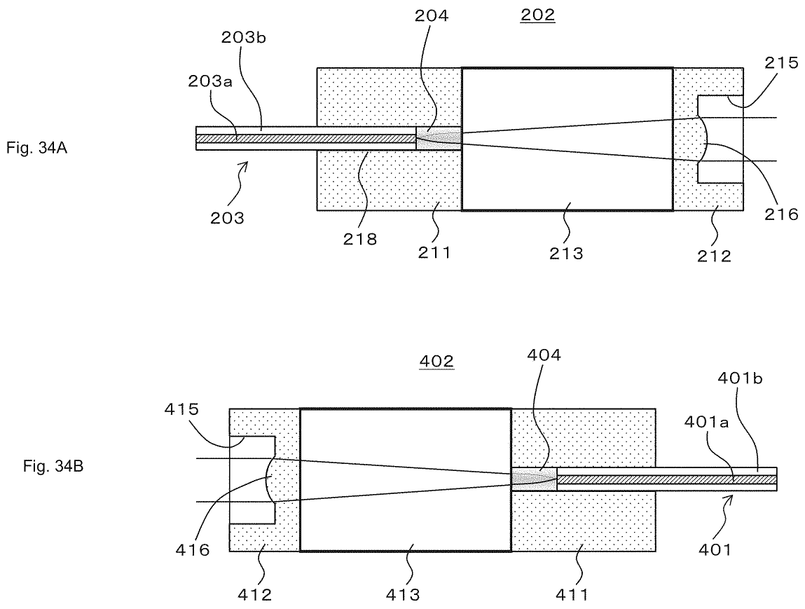

FIG. 34(a) is a cross-sectional view illustrating an example of the connector 202 of the transmitter 200. In the illustrated example, the illustration of the position regulating portions 217 (see FIG. 32) is omitted. Referring to FIG. 34(a), the connector 202 will be further described below.

The connector 202 includes the connector body 211. The connector body 211 is configured with, for example, a resin member or a glass member. The plurality of optical fiber insertion holes 218 extending forward from the rear side are provided in alignment with the lenses 216 for the channels while being arranged in the horizontal direction in the connector body 211. The optical fiber 203 has a double structure including a central core 203a serving as an optical path and a cladding 203b surrounding the core 203a.

The optical fibers 203 for the channels are inserted into the respective optical-fiber insertion holes 218 and are fixed therein with the distal end sides in contact with the GRIN lenses 204. In this case, at the front side of the connector body 211, the GRIN lenses 204 are provided in contact with the optical fibers 203 for the channels.

Moreover, the connector 202 includes the lens member 212. The lens member 212 is configured with a resin member. At the front side of the lens member 212, a concave light-emitting portion (light transmission space) 215 is formed. The lens member 212 includes a plurality of lenses (convex lenses) 216 that are integrally formed for the respective channels while being arranged in the horizontal direction, the lenses 216 being located at the bottom portion of the light-emitting portion 215.

The connector 202 further includes the high-transmittance portion 213. The high-transmittance portion 213 is configured with a member having a higher transmittance than the lens member 212, for example, a glass member. The high-transmittance portion 213 is disposed between the connector body 211 and the lens member 212 and acts as a spacer. Thus, even if the lens thickness (the thickness of the lens member 212) is suppressed, a certain length is ensured as a distance between one end of the optical fiber 203 and the lens 216 serving as a collimator lens, thereby increasing the diameter of a collimated light beam.

In the connector 202, the lens 216 has the function of shaping light emitted from the optical fiber 203 into a collimated light beam and emitting the collimated light beam. Thus, light emitted from the output end of the optical fiber 203 with a predetermined NA is caused to enter the lens 216 through the GRIN lens 204, the high-transmittance portion 213, and the lens member 212, is shaped into a collimated light beam, and then is emitted.

FIG. 34(b) is a cross-sectional view illustrating an example of the connector 402 of the cable 400. In the illustrated example, the illustration of the position regulating portions 417 (see FIGS. 32 and 33) is omitted. Referring to FIG. 34(b), the connector 402 will be further described below.

The connector 402 includes the connector body 411. The connector body 411 is configured with, for example, a resin member or a glass member. The plurality of optical fiber insertion holes 418 extending forward from the rear side are provided in alignment with the lenses 416 for the channels while being arranged in the horizontal direction in the connector body 411. The optical fiber 401 has a double structure including a central core 401a serving as an optical path and a cladding 402b surrounding the core 401a.

The optical fibers 401 for the channels are inserted into the respective optical-fiber insertion holes 418 and are fixed therein with the distal end sides in contact with the GRIN lenses 404. In this case, at the front side of the connector body 411, the GRIN lenses 404 are provided in contact with the optical fibers 401 for the channels.

Moreover, the connector 402 includes the lens member 412. The lens member 412 is configured with a resin member. At the front side of the lens member 412, the concave light incident portion (light transmission space) 415 is formed. The lens member 412 includes the plurality of lenses (convex lenses) 416 that are integrally formed for the respective channels while being arranged in the horizontal direction, the lenses 416 being located at the bottom portion of the light incident portion 415.

The connector 402 further includes the high-transmittance portion 413. The high-transmittance portion 413 is configured with a member having a higher transmittance than the lens member 412, for example, a glass member. The high-transmittance portion 413 is disposed between the connector body 411 and the lens member 412 and acts as a spacer. Thus, even if the lens thickness (the thickness of the lens member 412) is suppressed, a certain length is ensured as a distance between one end of the optical fiber 401 and the lens 416 serving as a condenser lens, thereby increasing the diameter of a collimated light beam.

In the connector 402 of the cable 400, the lens 416 has the function of condensing an incoming collimated light beam. In this case, the collimated light beam is incident on the lens 416 and is condensed therein, and then the condensed light is caused to enter the incident end of the optical fiber 401 with a predetermined NA through the lens member 412, the high-transmittance portion 413, and the GRIN lens 404.

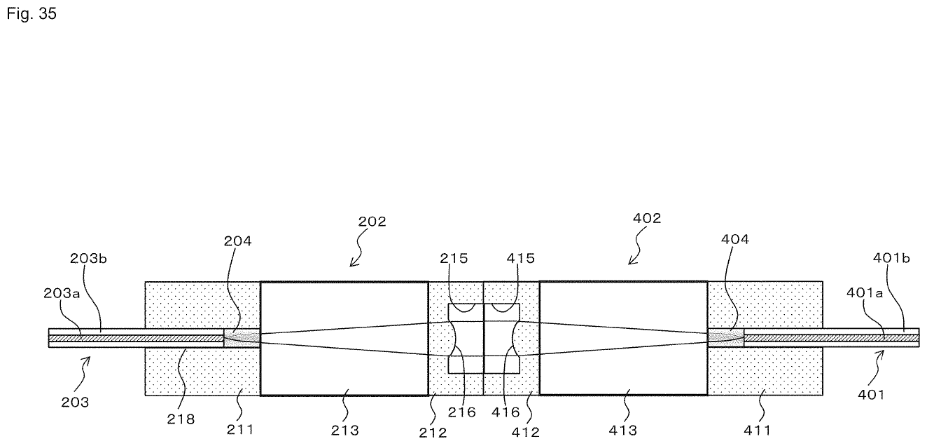

FIG. 35 is a cross-sectional view illustrating a state in which the connector 202 of the transmitter 200 and the connector 402 of the cable 400 are connected to each other. In the connector 202, light transmitted through the optical fiber 203 is emitted from the output end of the optical fiber 203 with a predetermined NA. The emitted light is caused to enter the lens 216 through the GRIN lens 204, the high-transmittance portion 213, and the lens member 212, is shaped into a collimated light beam, and is emitted to the connector 402.

In the connector 402, light emitted from the connector 202 is caused to enter the lenses 416 and is condensed therein. The condensed light is then caused to enter the incident end of the optical fiber 401 through the lens member 412, the high-transmittance portion 413, and the GRIN lens 404 and is transmitted through the optical fiber 401.

In the foregoing example, when the connector 202 and the connector 402 are connected, alignment is performed using the concave position regulating portions 217 formed integrally with the lens member 212 and the convex position regulating portions 417 formed integrally with the lens member 412.

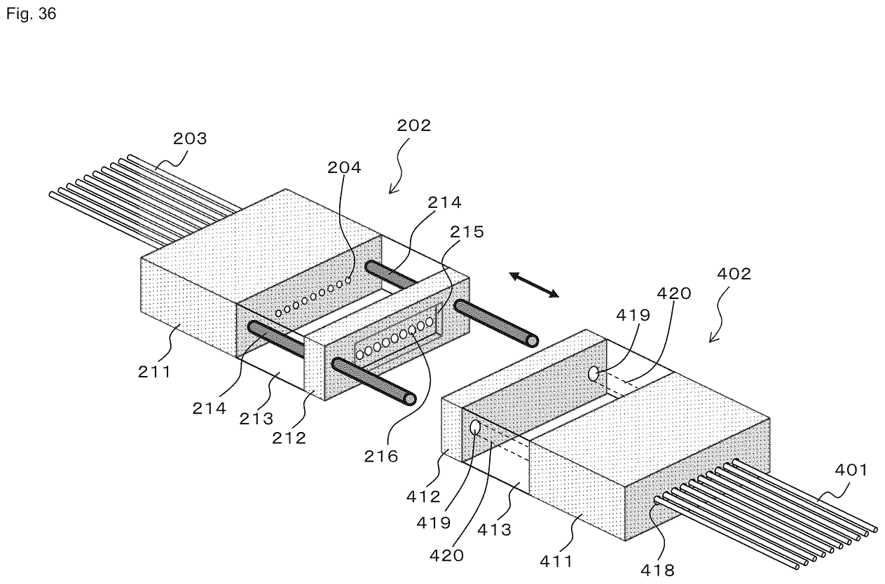

FIG. 36 illustrates an example in which alignment is performed using the positioning pins 214 when the connector 202 and the connector 402 are connected. In FIG. 36, parts corresponding to those in FIG. 32 are designated by the same reference numerals, and detailed descriptions thereof are omitted as appropriate.

The connector 202 has the positioning pins 214 penetrating the lens member 212 and projecting toward the front side. For the connector 402, the lens member 412 and the high-transmittance portion 413 further include through holes 419 and 420 where the projecting portions of the positioning pins 214 are inserted. The connector body 411 also includes holes, which are not illustrated, such that the distal ends of the projecting portions of the positioning pins 214 are inserted into the holes.

In this example, the connector 402 does not include positioning pins (the positioning pins 414 in FIGS. 32 and 33) for optical axis alignment between the cores of the optical fibers 401 for the channels and the lenses 416 for the channels, the optical fibers 401 being held by the connector body 411, the lenses 416 being machined and formed on the lens member 412. Thus, as a method for manufacturing the connector 402, it is assumed that the members are first bonded and fixed with the attached positioning pins, and then the positioning pins are removed.

In the example of FIG. 36, when the connector 202 and the connector 402 are connected to each other, the projecting portions of the positioning pins of the connector 202 penetrate the through holes 419 and 420 provided in the lens member 412 and the high-transmittance portion 413 of the connector 402, and the distal ends of the projecting portions are inserted into the holes, which are not illustrated, on the connector body 411. Thus, alignment is performed between the connector 202 and the connector 402.

In the example of FIG. 36, the structure of the connector 202 and the structure of the connector 402 may be reversed. Specifically, the connector 402 on the reception side may have the positioning pins 414 (see FIGS. 32 and 33) while the connector 202 on the transmission side may be configured without the positioning pins 214.

In the foregoing example, the high-transmittance portions 213 and 413 of the connectors 202 and 402 are configured with glass members.

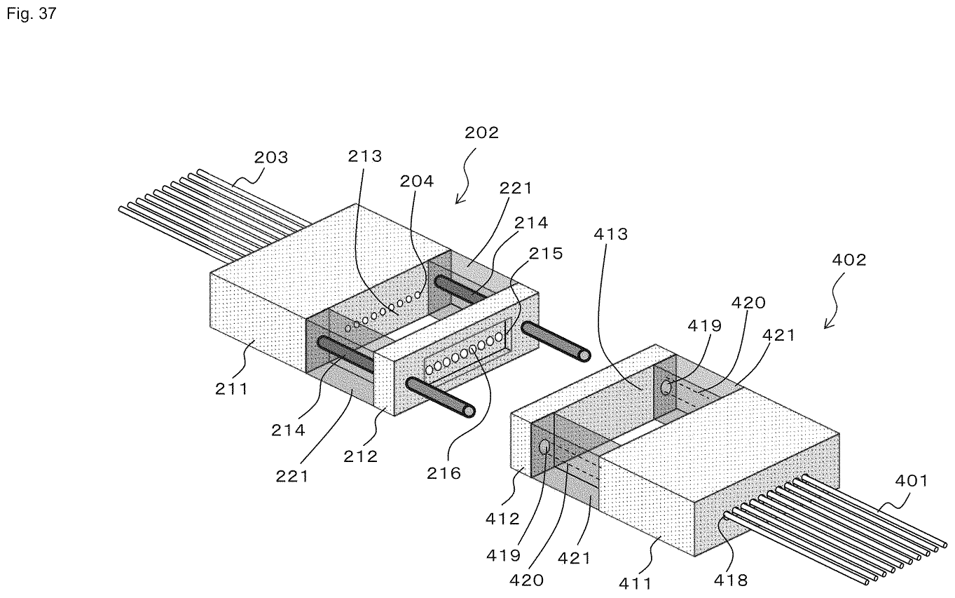

FIG. 37 illustrates an example in which the high-transmittance portions 213 and 413 of the connectors 202 and 402 are configured with spaces (air spaces). In FIG. 37, parts corresponding to those in FIG. 36 are designated by the same reference numerals, and detailed descriptions thereof are omitted as appropriate.

In this case, for the connector 202, spacers 221 are disposed in portions other than a central space portion in order to correctly secure a distance between the connector body 211 and the lens member 212. Likewise, for the connector 402, spacers 421 are disposed in portions other than a central space portion in order to correctly secure a distance between the connector body 411 and the lens member 412.

In the foregoing example, the GRIN lens 22T is provided as illustrated in FIG. 31. However, also in the absence of the GRIN lens 22T, even if a distance from the optical fiber 10T to the lens 11T is increased, the high-transmittance portion 14T is disposed so as to suppress the lens thickness (the thickness of the lens member 13T) and reduce the amount of optical loss occurring through the lens member 13T, thereby securing a diameter of a collimated light beam with a small amount of loss.

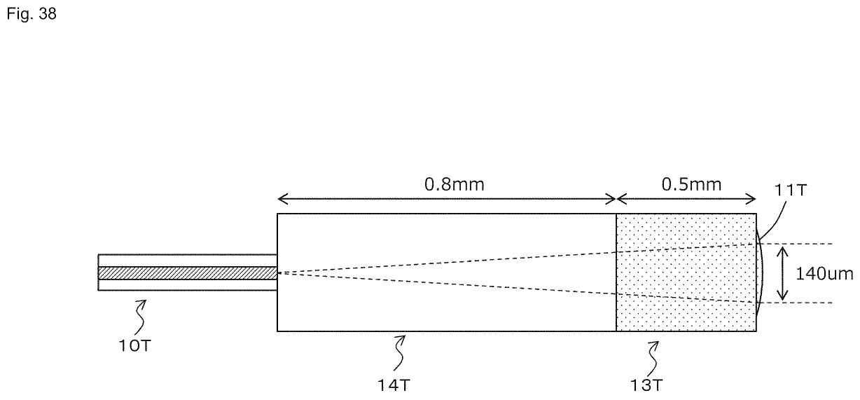

FIG. 38 illustrates an example of a structure not provided with the GRIN lens 22T. This example corresponds to the structure illustrated in FIG. 29(b). In this case, the high-transmittance portion 14T having a higher transmittance than the lens member 13T is disposed between the optical fiber 10T and the lens member 13T. A lens thickness of 0.5 mm is not limited to the numeric value.

In the foregoing description, the configuration example of the connector 202 of the transmitter 200 and the connector 402 of the cable 400 was described. The connector 403 of the cable 400 and the connector 301 of the receiver 300 are configured likewise. Detailed descriptions thereof are omitted.

In the foregoing example, the structure (optical interface structure) including the high-transmittance portion according to the present technique is applied to the part of the connector (optical connector). However, the structure may be applied to other parts, for example, the part of an optical module. Also in this case, the lens thickness (the thickness of the lens member) can be suppressed and the amount of optical loss through the lens member can be reduced, thereby securing a diameter of a collimated light beam with a small amount of loss.

The following will describe a configuration example of optical coupling between the light-emitting portion 201 and the optical fiber 203 of the optical communication system 100 in FIG. 30(b).

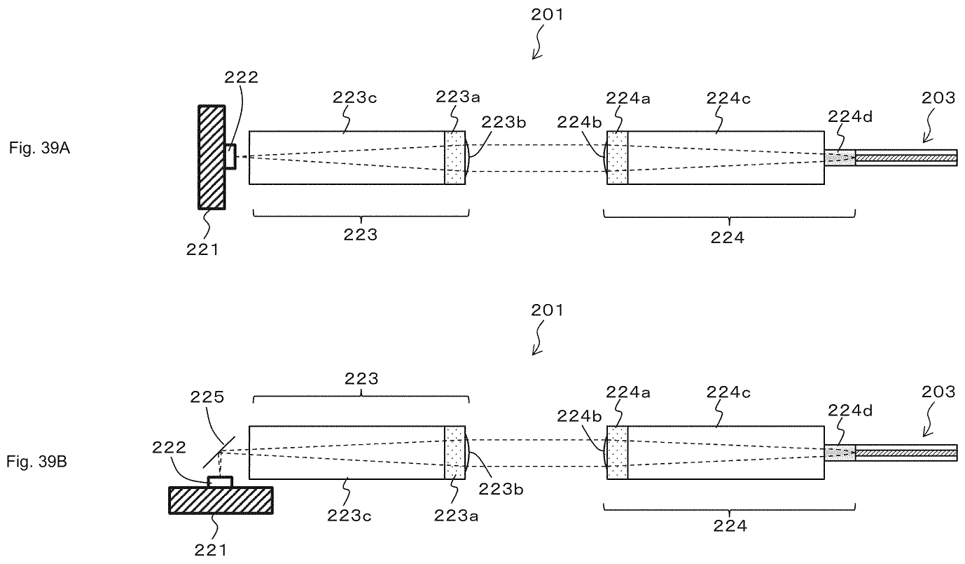

FIG. 39(a) illustrates a configuration example of optical coupling between the light-emitting portion 201 and the optical fiber 203. The light-emitting portion 201 includes a laser diode 222 such as a VCSEL (Vertical Cavity Surface Emitting Laser) placed on a substrate 221 and a transmitting unit 223 and a receiving unit 224 that are provided for coupling light emitted by the laser diode 222 with the optical fiber 203.

The transmitting unit 223 is configured such that a lens member 223a and a high-transmittance portion 223c are connected in series, the lens member 223a having a lens (collimating lens) 223b machined and shaped on the output end side, the high-transmittance portion 223c including a member having a higher transmittance than the lens member 223a, for example, a glass member. The receiving unit 224 is configured such that a lens member 224a, a high-transmittance portion 224c, and a GRIN lens 224d are connected in series, the lens member 224a having a lens (condenser lens) 224b machined and shaped on the input end side, the high-transmittance portion 224c including a member having a higher transmittance than the lens member 224a, for example, a glass member, the GRIN lens 224d constituting an optical path adjusting unit.

In this case, light emitted by the laser diode 222 is caused to enter the lens 223b through the high-transmittance portion 223c and the lens member 223a of the transmitting unit 223, is shaped into a collimated light beam, and is emitted to the receiving unit 224. Light emitted from the transmitting unit 223 is caused to enter the lens 224b of the receiving unit 224 and is condensed therein, is caused to enter the incident end of the optical fiber 203 through the lens member 224a, the high-transmittance portion 224c, and the GRIN lens 224d, and is transmitted through the optical fiber 203.

In the example of FIG. 39(a), the high-transmittance portion 223c of the transmitting unit 223 and the high-transmittance portion 224c of the receiving unit 224 may be configured with spaces (air spaces). The same applies to other configuration examples below.

FIG. 39(b) illustrates another configuration example of optical coupling between the light-emitting portion 201 and the optical fiber 203. In FIG. 39(b), parts corresponding to those in FIG. 39(a) are designated by the same reference numerals, and detailed descriptions thereof are omitted as appropriate.

In this example, light from the laser diode 222 placed on the substrate 221 is bent 90° and is caused to enter the high-transmittance portion 223c of the transmitting unit 223. Thus, in this example, a mirror 225 is provided to bend light 900 from the laser diode 222. Other configurations are identical to those in the example of FIG. 39(a). In this case, light emitted by the laser diode 222 is bent 90° by the mirror 225, is caused to enter the high-transmittance portion 223c of the transmitting unit 223, is caused to enter the lens 223b through the high-transmittance portion 223c and the lens member 223a, is shaped into a collimated light beam, and is emitted to the receiving unit 224.

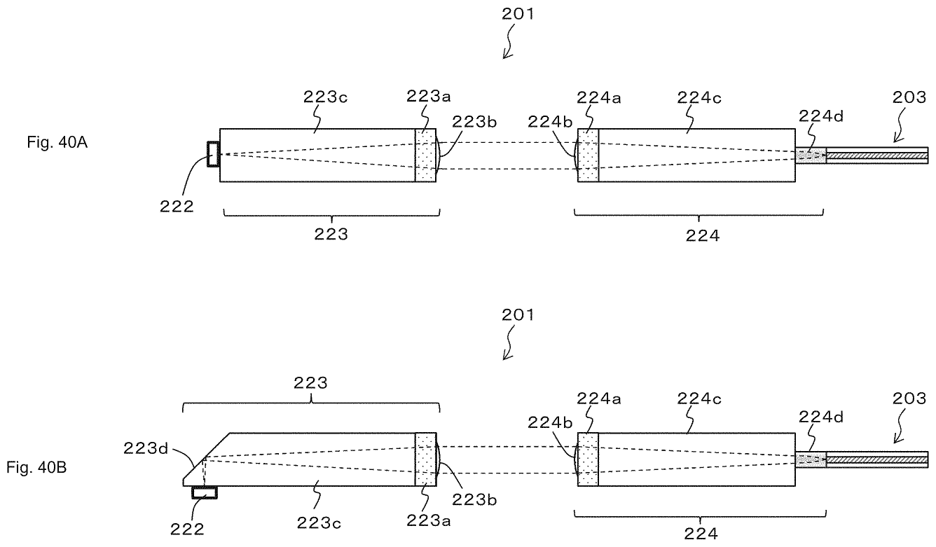

FIG. 40(a) illustrates another configuration example of optical coupling between the light-emitting portion 201 and the optical fiber 203. In FIG. 40(a), parts corresponding to those in FIG. 39(a) are designated by the same reference numerals, and detailed descriptions thereof are omitted as appropriate.

In this example, the laser diode 222 is directly fixed to the high-transmittance portion 223c configured with, for example, a glass member. Other configurations are identical to those in the example of FIG. 39(a). In this case, light emitted by the laser diode 222 directly fixed to the high-transmittance portion 223c of the transmitting unit 223 is caused to enter the high-transmittance portion 223c, is caused to enter the lens 223b through the high-transmittance portion 223c and the lens member 223a, is shaped into a collimated light beam, and is emitted to the receiving unit 224.

FIG. 40(b) illustrates another configuration example of optical coupling between the light-emitting portion 201 and the optical fiber 203. In FIG. 40(b), parts corresponding to those in FIG. 39(a) are designated by the same reference numerals, and detailed descriptions thereof are omitted as appropriate.

Also in this example, the laser diode 222 is directly fixed to the high-transmittance portion 223c. In this example, the laser diode 222 is directly fixed to a surface orthogonal to the fixing surface of the example in FIG. 40(a) and light caused to enter the high-transmittance portion 223c is bent 90° on a mirror surface 223e formed on the high-transmittance portion 223c. Other configurations are identical to those in the example of FIG. 39(a).

In this case, light emitted by the laser diode 222 directly fixed to the high-transmittance portion 223c is caused to enter the high-transmittance portion 223c of the transmitting unit 223, is bent 90° on a mirror surface 223d, is caused to enter the lens 223b through the high-transmittance portion 223c and the lens member 223a, is shaped into a collimated light beam, and is emitted to the receiving unit 224.

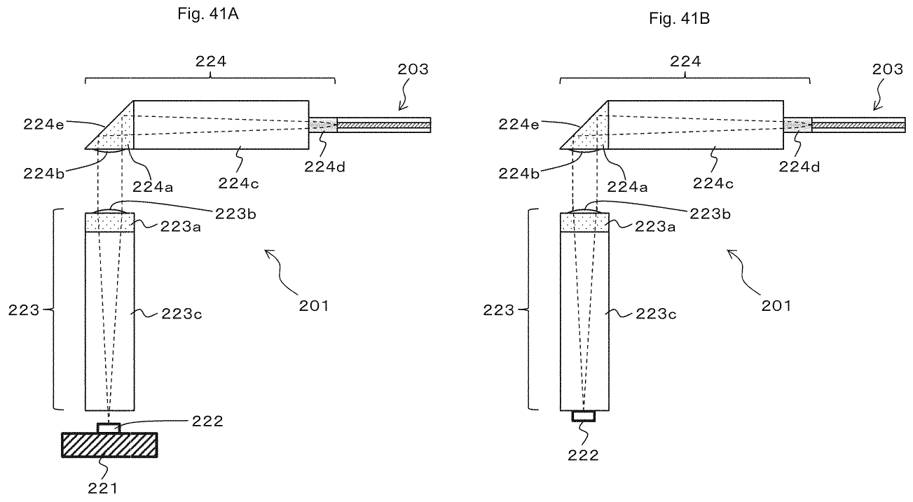

FIG. 41(a) illustrates another configuration example of optical coupling between the light-emitting portion 201 and the optical fiber 203. In FIG. 41(a), parts corresponding to those in FIG. 39(a) are designated by the same reference numerals, and detailed descriptions thereof are omitted as appropriate.

In this example, light caused to enter the lens 224b of the receiving unit 224 is bent 90° on a mirror surface 224e formed on the lens member 224a. Other configurations are identical to those in the example of FIG. 39(a).

In this case, light caused to enter the lens 224b of the receiving unit 224 is bent 90° on a mirror surface 224e of the lens member 224a and is caused to enter the incident end of the optical fiber 203 through the lens member 224a, the high-transmittance portion 224c, and the GRIN lens 224d.

FIG. 41(b) illustrates another configuration example of optical coupling between the light-emitting portion 201 and the optical fiber 203. In FIG. 41(b), parts corresponding to those in FIG. 41(a) are designated by the same reference numerals, and detailed descriptions thereof are omitted as appropriate.

Also in this example, light caused to enter the lens 224b of the receiving unit 224 is bent 90° on a mirror surface 224e formed on the lens member 224a. In this example, the laser diode 222 is directly fixed to the high-transmittance portion 223c of the transmitting unit 223, the high-transmittance portion 223c being configured with, for example, a glass member. Other configurations are identical to those in the example of FIG. 41(a).

In this case, light emitted by the laser diode 222 directly fixed to the high-transmittance portion 223c of the transmitting unit 223 is caused to enter the high-transmittance portion 223c, is caused to enter the lens 223b through the high-transmittance portion 223c and the lens member 223a, is shaped into a collimated light beam, and is emitted to the receiving unit 224. Light caused to enter the lens 224b of the receiving unit 224 from the transmitting unit 223 is bent 90° on the mirror surface 224e of the lens member 224a and is caused to enter the incident end of the optical fiber 203 through the lens member 224a, the high-transmittance portion 224c, and the GRIN lens 224d.

In the examples of FIGS. 39(a), 39(b), 40(a), 40(b), 41(a), and 41(b), the receiving unit 224 includes the GRIN lens 224d. The GRIN lens 224d may be absent in the receiving unit 224.

### 2. Modification Example

Moreover, in the foregoing embodiment, the first wavelength is 1310 nm. Since a laser light source or an LED light source may be used as a light source, the first wavelength is assumed to be, for example, 300 nm to 5 μm.

Furthermore, in the foregoing embodiment, the first wavelength is 1310 nm. The first wavelength may be a wavelength of a 1310-nm range including 1310 nm. Moreover, in the foregoing embodiment, the first wavelength is 1310 nm. The first wavelength may be 1550 nm or a wavelength of a 1550-nm range including 1550 nm. Although the second wavelength is described as 850 nm, the second wavelength may be a wavelength in the 850-nm band including 850 nm.

The foregoing embodiment described examples in which the optical waveguide is an optical fiber. Naturally, the present technique is similarly applicable to an optical waveguide other than an optical fiber, for example, a silicon optical waveguide.

The preferred embodiment of the present disclosure has been described in detail with reference to the accompanying drawings. The technical scope of the present disclosure is not limited to the examples. It is apparent that those having ordinary knowledge in the technical field of the present disclosure could conceive various examples of changes or modifications within the scope of the technical ideas set forth in the claims, and it should be understood that these examples also naturally fall within the technical scope of the present disclosure.

Furthermore, the effects described in the present specification are merely explanatory or exemplary and are not intended as limiting. In other words, the techniques according to the present disclosure may exhibit other effects apparent to those skilled in the art from the description herein, in addition to or in place of the above effects.

The present technique can also have the following configurations:

(1) An optical interface structure including: optical members, each constituting a light emitter or a light receiver, and
a lens member having lens portions,
wherein a high-transmittance portion having a higher transmittance than the lens member is disposed between the optical member and the lens member.

(2) The optical interface structure according to (1), wherein the light emitter is an optical waveguide that emits an optical signal from one end of the optical waveguide or a light-emitting element that converts an electric signal into an optical signal and emits the signal.

(3) The optical interface structure according to (1) or (2), wherein the light receiver is an optical waveguide that receives an optical signal on one end of the optical waveguide or a light-receiving element that converts the received optical signal into an electric signal.

(4) The optical interface structure according to any one of (1) to (3), wherein the lens member is configured with a resin member, and the high-transmittance portion is configured with a glass member or a space.

(5) The optical interface structure according to (4), wherein if the high-transmittance portion is a space, a thickness of the space is kept at a predetermined thickness by a spacer.

(6) The optical interface structure according to any one of (1) to (5), wherein positioning between a ferrule holding the optical waveguide serving as the light emitter or the light receiver and the lens member is performed by using a positioning pin.

(7) The optical interface structure according to (6), wherein the ferrule holds the plurality of optical waveguides, and the lens member has the plurality of lens portions for the respective optical waveguides.

(8) The optical interface structure according to any one of (1) to (7), wherein if the optical member is a light emitter, the lens portion included in the lens member constitutes a collimating lens.

(9) The optical interface structure according to any one of (1) to (7), wherein if the optical member is a light receiver, the lens portion included in the lens member constitutes a condenser lens.

(10) The optical interface structure according to any one of (1) to (9), wherein the optical waveguide serving as the light emitter or the light receiver allows propagation only in a basic mode at a first wavelength, and
communications are performed through the optical waveguide by using light having a second wavelength and including at least components of a primary mode as well as the basic mode, and
the second wavelength is a wavelength where the optical waveguide allows propagation at least in the primary mode as well as the basic mode.

(11) The optical interface structure according to (10), further including a lens configured to adjust an optical path, the lens being disposed between the optical waveguide and the high-transmittance portion.

(12) The optical interface structure according to (11), wherein the lens configured to adjust the optical path has a refractive index of a gradation structure in which the refractive index decreases in a vertical direction from an optical axis.

(13) An optical connector including: a lens member having lens portions, and a high-transmittance portion that is disposed between an optical waveguide and the lens member and has a higher transmittance than the lens member.

(14) The optical connector according to (13), wherein the optical waveguide allows propagation only in a basic mode at a first wavelength, and
communications are performed through the optical waveguide by using light having a second wavelength and including at least components of a primary mode as well as the basic mode, and
the second wavelength is a wavelength where the optical waveguide allows propagation at least in the primary mode as well as the basic mode.

(15) The optical connector according to (14), further including a lens configured to adjust an optical path, the lens being disposed between the optical waveguide and the high-transmittance portion.

(16) The optical connector according to (15), wherein the lens configured to adjust the optical path has a refractive index of a gradation structure in which the refractive index decreases in a vertical direction from an optical axis.

(17) A transmitter including an optical connector configured to output an optical signal,
wherein the optical connector includes:
a lens member having lens portions configured to output the optical signal to the outside, the optical signal being emitted from one end of an optical waveguide; and
a high-transmittance portion that is disposed between the optical waveguide and the lens member and has a higher transmittance than the lens member.

(18) A receiver including an optical connector configured to input an optical signal, wherein the optical connector includes:
a lens member having lens portions configured to receive the optical signal on one end of an optical waveguide, the optical signal being inputted from the outside; and
a high-transmittance portion that is disposed between the lens member and the optical waveguide and has a higher transmittance than the lens member.

(19) An optical cable including an optical connector configured to input or output an optical signal,
wherein the optical connector includes:
a lens member having lens portions; and
a high-transmittance portion that is disposed between the optical waveguide and the lens member and has a higher transmittance than the lens member.

(20) An optical communication system in which a transmitter and a receiver are connected to each other via an optical cable,
wherein the transmitter, the receiver, and the optical cable each include an optical connector, and
the optical connector includes:
a lens member having lens portions, and
a high-transmittance portion that is disposed between the optical waveguide and the lens member and has a higher transmittance than the lens member.

### REFERENCE SIGNS LIST

10T, 10R Optical fiber
10a Core
10b Clad
11T, 11R Lens
12R Lens
13T, 13R Lens member
22R, 22T GRIN lens
100 Optical communication system
200 Transmitter
201 Light emitting unit
202 Connector (receptacle)
203 Optical fiber
203a Core
203b Clad
204 GRIN lens
211 Connector body (ferrule)
212 Lens member
213 High-transmittance portion
214 Positioning pin
215 Light-emitting portion (light transmission space)
216 Lens (convex lens)
217 Position regulating portion
218 Optical-fiber insertion hole
221 Substrate
222 Laser diode
223 Transmitting unit
223a Lens member
223b Lens
223c High-transmittance portion
223d Mirror surface
224 Receiving unit
224a Lens member
224b Lens
224c High-transmittance portion
224d GRIN lens
224e Mirror surface
300 Receiver
301 Connector (receptacle)
302 Light-receiving portion
303 Optical fiber
400 Optical cable
401 Optical fiber
402,403 Connector (plug)
411 Connector body (ferrule)
412 Lens member
413 High-transmittance portion
414 Positioning pin
415 Light incident portion (light transmission space)
416 Lens (convex lens)
417 Position regulating portion
418 Optical-fiber insertion hole
419,420 Through hole
421 Spacer.

1. An optical interface structure comprising: optical members, each constituting a light emitter or a light receiver, and
a lens member having lens portions,
wherein a high-transmittance portion having a higher transmittance than the lens member is disposed between the optical member and the lens member.

2. The optical interface structure according to claim 1, wherein the light emitter is an optical waveguide that emits an optical signal from one end of the optical waveguide or a light-emitting element that converts an electric signal into an optical signal and emits the signal.

3. The optical interface structure according to claim 1, wherein the light receiver is an optical waveguide that receives an optical signal on one end of the optical waveguide or a light-receiving element that converts the received optical signal into an electric signal.

4. The optical interface structure according to claim 1, wherein the lens member is configured with a resin member, and the high-transmittance portion is configured with a glass member or a space.

5. The optical interface structure according to claim 4, wherein if the high-transmittance portion is a space, a thickness of the space is kept at a predetermined thickness by a spacer.

6. The optical interface structure according to claim 1, wherein positioning between a ferrule holding the optical waveguide serving as the light emitter or the light receiver and the lens member is performed by using a positioning pin.

7. The optical interface structure according to claim 6, wherein the ferrule holds the plurality of optical waveguides, and the lens member has the plurality of lens portions for the respective optical waveguides.

8. The optical interface structure according to claim 1, wherein if the optical member is a light emitter, the lens portion included in the lens member constitutes a collimating lens.

9. The optical interface structure according to claim 1, wherein if the optical member is a light receiver, the lens portion included in the lens member constitutes a condenser lens.

10. The optical interface structure according to claim 1, wherein the optical waveguide serving as the light emitter or the light receiver allows propagation only in a basic mode at a first wavelength, and
communications are performed through the optical waveguide by using light having a second wavelength and including at least components of a primary mode as well as the basic mode, and
the second wavelength is a wavelength where the optical waveguide allows propagation at least in the primary mode as well as the basic mode.

11. The optical interface structure according to claim 10, further comprising a lens configured to adjust an optical path, the lens being disposed between the optical waveguide and the high-transmittance portion.

12. The optical interface structure according to claim 11, wherein the lens configured to adjust the optical path has a refractive index of a gradation structure in which the refractive index decreases in a vertical direction from an optical axis.

13. An optical connector comprising: a lens member having lens portions, and
a high-transmittance portion that is disposed between an optical waveguide and the lens member and has a higher transmittance than the lens member.

14. The optical connector according to claim 13, wherein the optical waveguide allows propagation only in a basic mode at a first wavelength, and
communications are performed through the optical waveguide by using light having a second wavelength and including at least components of a primary mode as well as the basic mode, and
the second wavelength is a wavelength where the optical waveguide allows propagation at least in the primary mode as well as the basic mode.

15. The optical connector according to claim 14, further comprising a lens configured to adjust an optical path, the lens being disposed between the optical waveguide and the high-transmittance portion.

16. The optical connector according to claim 15, wherein the lens configured to adjust the optical path has a refractive index of a gradation structure in which the refractive index decreases in a vertical direction from an optical axis.

17. A transmitter comprising an optical connector configured to output an optical signal,
wherein the optical connector includes:
a lens member having lens portions configured to output the optical signal to outside, the optical signal being emitted from one end of an optical waveguide; and
a high-transmittance portion that is disposed between the optical waveguide and the lens member and has a higher transmittance than the lens member.

18. A receiver comprising an optical connector configured to input an optical signal, wherein the optical connector includes:
a lens member having lens portions configured to receive the optical signal on one end of an optical waveguide, the optical signal being inputted from outside; and
a high-transmittance portion that is disposed between the lens member and the optical waveguide and has a higher transmittance than the lens member.

19. An optical cable comprising an optical connector configured to input or output an optical signal,
wherein the optical connector includes:
a lens member having lens portions; and
a high-transmittance portion that is disposed between the optical waveguide and the lens member and has a higher transmittance than the lens member.

20. An optical communication system in which a transmitter and a receiver are connected to each other via an optical cable,
wherein the transmitter, the receiver, and the optical cable each include an optical connector, and
the optical connector includes:
a lens member having lens portions, and
a high-transmittance portion that is disposed between the optical waveguide and the lens member and has a higher transmittance than the lens member.
